(19) United States
(12) Patent Application Publication
(10) Pub. No.: US 2024/0121403 A1
(43) Pub. Date: Apr. 11, 2024

(54) METADATA FOR SIGNALING INFORMATION REPRESENTATIVE OF AN ENERGY CONSUMPTION OF A DECODING PROCESS

(71) Applicant: INTERDIGITAL VC HOLDINGS FRANCE, SAS, Cesson Sevigne (FR)

(72) Inventors: Edouard Francois, Bourg des Comptes (FR); Milos Radosavljevic, Rennes (FR); Erik Reinhard, Hédé-Bazouges (FR); Christel Chamaret, Chantepie (FR)

(21) Appl. No.: 18/275,679

(22) PCT Filed: Jan. 18, 2022
(86) PCT No.: PCT/EP2022/050947

§ 371 Date: Aug. 3, 2023

(30) Foreign Application Priority Data
Feb. 3, 2021 (EP) 21305142.8
Aug. 13, 2021 (EP) 21306117.9

(51) Int. Cl. H04N 19/156; H04N 19/127; H04N 19/132; H04N 19/172; H04N 19/176; H04N 19/46

(52) U.S. Cl. CPC H04N 19/156; H04N 19/127; H04N 19/132; H04N 19/172; H04N 19/176; H04N 19/46

(57) ABSTRACT

A method comprising signaling (102) in a data structure metadata representative of an energy consumption induced by encoding tools and/or features implemented to obtain a video stream representative of a sequence of pictures; and, associating (103) the data structure to the video stream for at least one subset of pictures representative of a period of the video stream; wherein at least one encoding tool or feature is associated to an information representative of an energy consumption depending on: a single reference picture size defined for the sequence of pictures; or, a total number of blocks of a given size in pictures signaled in the metadata for the at least one subset of pictures; or, a number of samples per square and rectangular blocks

### 1. TECHNICAL FIELD

At least one of the present embodiments generally relates to a method and an apparatus for signaling and obtaining information representative of an energy consumption of a decoding process.

### 2. BACKGROUND

Energy consumption is a key issue for end devices, especially for mobile sets with limited energy power resources. Even for TV sets, limiting their energy consumption is a relevant intent. Even if video decoding is not the main part of the energy consumption of such devices (typically around 15% in a mobile phone, while display is closer to 50%), being able to reduce its energy impact is beneficial, as well as for any process involved in the rendering of the video.

The green MPEG standard (ISO-IEC-23001-11), called green MPEG in the following, defines metadata to indicate to a decoder compliant with the standard AVC (ISO/CEI 14496-10/ITU-T H.264) or with the standard HEVC (ISO/IEC 23008-2—MPEG-H Part 2, High Efficiency Video Coding/ITU-T H.265)) complexity information or metrics (CMs) related to a bitstream, that enables the decoder to optimize its energy usage. The metadata is precisely adapted to the AVC and HEVC designs.

A new video coding standard called VVC (Versatile Video Coding) was recently developed by a joint collaborative team of ITU-T and ISO/IEC experts known as the Joint Video Experts Team (JVET). VVC comprises many new tools and features that prevent a direct use of the CMs metadata originally specified for AVC and HEVC. The new tools and features of VVC have significantly increased the complexity of the VVC decoding process comparing to the AVC or HEVC decoding process. This increased complexity renders a need of tools allowing controlling the energy consumption even more important.

It is desirable to propose solutions allowing to overcome the above issues. In particular, it is desirable to propose CMs metadata better adapted to standards comprising the new tools and features of VVC.

### 3. BRIEF SUMMARY

In a first aspect, one or more of the present embodiments provide a method comprising signaling in a data structure metadata representative of an energy consumption induced by encoding tools and/or features implemented to obtain a video stream representative of a sequence of pictures; and, associating the data structure to the video stream for at least one subset of pictures representative of a period of the video stream; wherein at least one encoding tool or feature is associated to an information representative of an energy consumption depending on: a single reference picture size defined for the sequence of pictures; or, a total number of blocks of a given size in pictures signaled in the metadata for the at least one subset of pictures; or, a number of samples per square and rectangular blocks.

In an embodiment, the data structure is a SEI message.

In an embodiment, the information representative of an energy consumption depends on a single reference picture size defined for the sequence of pictures responsive to the subset of pictures comprising a plurality of pictures.

In an embodiment, the at least one encoding tool or feature associated to an information representative of an energy consumption depending on the total number of blocks of the given size in pictures signaled in the metadata is related to at least one of: entropy decoding; inverse transform; intra prediction and intra blocks decoding; inter prediction and inter blocks decoding; interpolation for temporal prediction; in-loop filtering; a use of subpictures.

In an embodiment, the information representative of an energy consumption is applicable to a single picture or to all pictures in decoding order up to a next picture containing an intra slice, or over a specified time interval, or over a specified number of pictures counted in decoding order, or to a single picture with a slice, or tile granularity, or to a single picture with subpicture granularity.

In an embodiment, a first method is applied to derive the total number of blocks of a given size in pictures responsive to the information representative of an energy consumption is applicable to a single picture with a slice or tile granularity; and,
a second method is applied to derive the total number of blocks of a given size in pictures responsive to the information representative of an energy consumption is applicable to a single picture with subpicture granularity.

In an embodiment, the total number of blocks of a given size in pictures is signaled in the metadata for the at least one subset of pictures.

In a second aspect, one or more of the present embodiments provide a method comprising: obtaining a data structure associated to a video stream for at least one subset of pictures representative of a period of a sequence of pictures represented by the video stream and comprising metadata representative of an energy consumption induced by encoding tools and/or features implemented to obtain the video stream wherein at least one encoding tool or feature is associated to an information representative of an energy consumption depending on: a single reference picture size defined for the sequence of pictures; or, a total number of blocks of a given size in pictures signaled in the metadata for the at least one subset of pictures; or, a number of samples per square and rectangular blocks.

In an embodiment, the data structure is a SEI message.

In an embodiment, the information representative of an energy consumption depends on a single reference picture size defined for the sequence of pictures responsive to the subset of pictures comprising a plurality of pictures.

In an embodiment, the at least one encoding tool or feature associated to an information representative of an energy consumption depending on the total number of blocks of the given size in pictures signaled in the metadata is related to at least one of:
entropy decoding; inverse transform; intra prediction and intra blocks decoding; inter prediction and inter blocks decoding; interpolation for temporal prediction; in-loop filtering; a use of subpictures.

In an embodiment, the information representative of an energy consumption is applicable to a single picture or to all pictures in decoding order up to a next picture containing an intra slice, or over a specified time interval, or over a specified number of pictures counted in decoding order, or to a single picture with a slice, or tile granularity, or to a single picture with subpicture granularity.

In an embodiment,
a first method is applied to derive the total number of blocks of a given size in pictures responsive to the information representative of an energy consumption is applicable to a single picture with a slice or tile granularity; and,
a second method is applied to derive the total number of blocks of a given size in pictures responsive to the information representative of an energy consumption is applicable to a single picture with subpicture granularity.

In an embodiment, the total number of blocks of a given size in pictures is signaled in the metadata for the at least one subset of pictures.

In a third aspect, one or more of the present embodiments provide a device comprising: means for signaling in a data structure metadata representative of an energy consumption induced by encoding tools and/or features implemented to obtain a video stream representative of a sequence of pictures; and, means for associating the data structure to the video stream for at least one subset of pictures representative of a period of the video stream; wherein at least one encoding tool or feature is associated to an information representative of an energy consumption depending on: a single reference picture size defined for the sequence of pictures; or, a total number of blocks of a given size in pictures signaled in the metadata for the at least one subset of pictures; or, a number of samples per square and rectangular blocks.

In an embodiment, the data structure is a SEI message.

In an embodiment, the information representative of an energy consumption depends on a single reference picture size defined for the sequence of pictures responsive to the subset of pictures comprising a plurality of pictures.

In an embodiment, the at least one encoding tool or feature associated to an information representative of an energy consumption depending on the total number of blocks of the given size in pictures signaled in the metadata is related to at least one of: entropy decoding; inverse transform; intra prediction and intra blocks decoding; inter prediction and inter blocks decoding; interpolation for temporal prediction; in-loop filtering; a use of subpictures.

In an embodiment, the information representative of an energy consumption is applicable to a single picture or to all pictures in decoding order up to a next picture containing an intra slice, or over a specified time interval, or over a specified number of pictures counted in decoding order, or to a single picture with a slice, or tile granularity, or to a single picture with subpicture granularity.

In an embodiment,
a first means is used to derive the total number of blocks of a given size in pictures responsive to the information representative of an energy consumption is applicable to a single picture with a slice or tile granularity; and,
a second means is used to derive the total number of blocks of a given size in pictures responsive to the information representative of an energy consumption is applicable to a single picture with subpicture granularity.

In an embodiment, the total number of blocks of a given size in pictures is signaled in the metadata for the at least one subset of pictures.

In a fourth aspect, one or more of the present embodiments provide a device comprising: means for obtaining a data structure associated to a video stream for at least one subset of pictures representative of a period of a sequence of pictures represented by the video stream and comprising metadata representative of an energy consumption induced by encoding tools and/or features implemented to obtain the video stream wherein at least one encoding tool or feature is associated to an information representative of an energy consumption depending on: a single reference picture size defined for the sequence of pictures; or, a total number of blocks of a given size in pictures signaled in the metadata for the at least one subset of pictures; or, a number of samples per square and rectangular blocks.

In an embodiment, the data structure is a SEI message.

In an embodiment, the information representative of an energy consumption depends on a single reference picture size defined for the sequence of pictures responsive to the subset of pictures comprising a plurality of pictures.

In an embodiment, the at least one encoding tool or feature associated to an information representative of an energy consumption depending on the total number of blocks of the given size in pictures signaled in the metadata is related to at least one of: entropy decoding; inverse transform; intra prediction and intra blocks decoding; inter prediction and inter blocks decoding; interpolation for temporal prediction; in-loop filtering; a use of subpictures.

In an embodiment, the information representative of an energy consumption is applicable to a single picture or to all pictures in decoding order up to a next picture containing an intra slice, or over a specified time interval, or over a specified number of pictures counted in decoding order, or to a single picture with a slice, or tile granularity, or to a single picture with subpicture granularity.

In an embodiment:
a first means is applied to derive the total number of blocks of a given size in pictures responsive to the information representative of an energy consumption is applicable to a single picture with a slice or tile granularity; and,
a second means is applied to derive the total number of blocks of a given size in pictures responsive to the information representative of an energy consumption is applicable to a single picture with subpicture granularity.

In an embodiment, the total number of blocks of a given size in pictures is signaled in the metadata for the at least one subset of pictures.

In a fifth aspect, one or more of the present embodiments provide an apparatus comprising a device according to the third of fourth aspect.

In a sixth aspect, one or more of the present embodiments provide a signal generated by the method of first aspect or by the device of third aspect.

In a seventh aspect, one or more of the present embodiments provide a computer program comprising program code instructions for implementing the method according to the first or the second aspect.

In a eighth aspect, one or more of the present embodiments provide a non-transitory information storage medium storing program code instructions for implementing the method according to the first or the second aspect.

### 4. BRIEF SUMMARY OF THE DRAWINGS

FIG. 1A describes an example of a context in which embodiments can be implemented;

FIG. 1B illustrates an example of process in which various embodiments can be implemented;

FIG. 2 illustrates schematically an example of partitioning undergone by a picture of pixels of an original video;

FIG. 3 depicts schematically a method for encoding a video stream;

FIG. 4 depicts schematically a method for decoding an encoded video stream;

FIG. 5A illustrates schematically an example of hardware architecture of a processing module able to implement an encoding module or a decoding module in which various aspects and embodiments are implemented;

FIG. 5B illustrates a block diagram of an example of a first system in which various aspects and embodiments are implemented;

FIG. 5C illustrates a block diagram of an example of a second system in which various aspects and embodiments are implemented;

FIG. 6 illustrates schematically an embodiment;

FIG. 7 illustrates a block diagram of a decoding process in which various aspects and embodiments are implemented;

FIG. 8A illustrates an example of signaling process of an embodiment; and,

FIG. 8B illustrates an example of decoding process of an embodiment.

### 5. DETAILED DESCRIPTION

The following examples of embodiments are described in the context of a video format similar to VVC. However, these embodiments are not limited to the video coding/decoding method corresponding to VVC. These embodiments are in particular adapted to any video format using at least one of the tools or features used in AVC, HEVC and VVC. Such formats comprise for example the standard EVC (Essential Video Coding/MPEG-5), AV1 and VP9.

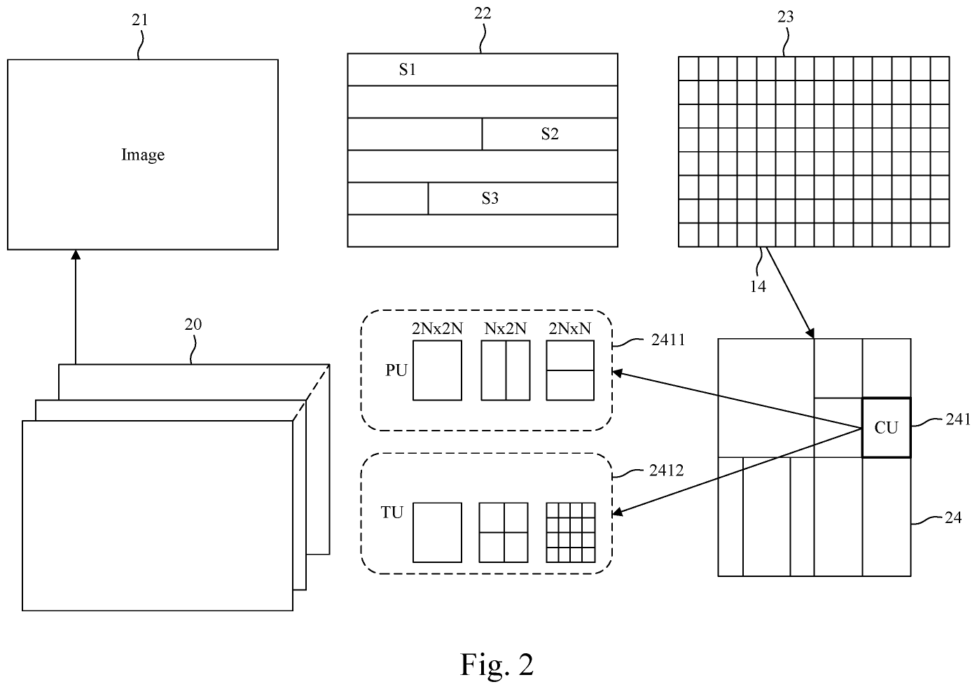

FIGS. 2, 3 and 4 introduce an example of video format.

FIG. 2 illustrates an example of partitioning undergone by a picture of pixels 21 of an original video 20. It is considered here that a pixel is composed of three components: a luminance component and two chrominance components. Other types of pixels are however possible comprising less or more components such as only a luminance component or an additional depth component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. N is generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. A particular type of tile prevent spatial and temporal predictions from samples from other tiles. These tiles are called subpictures. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

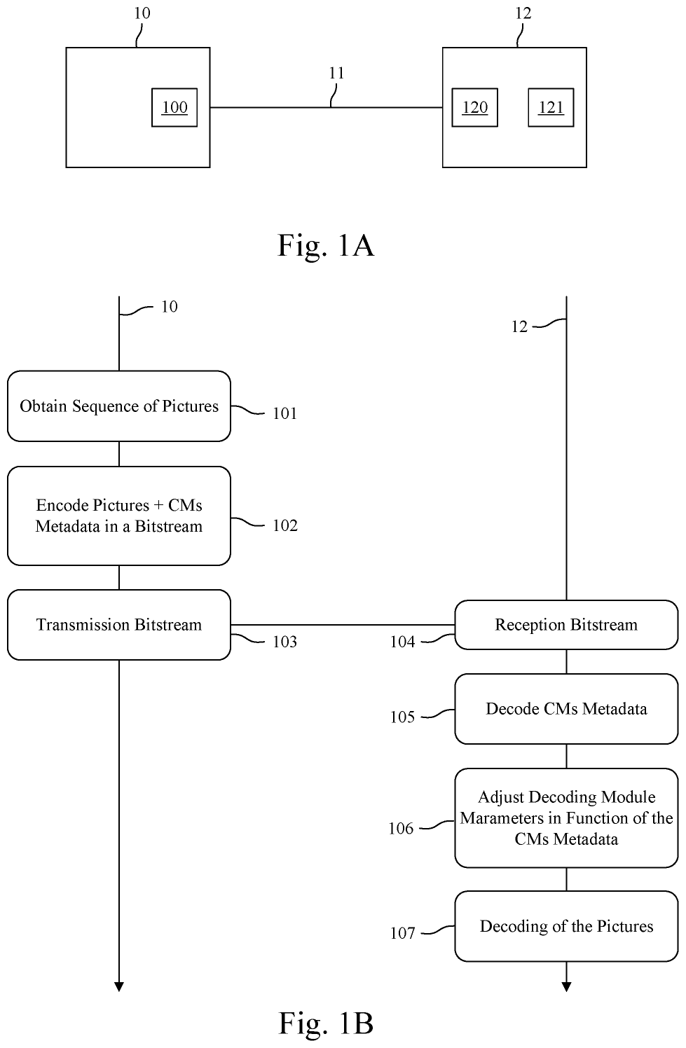

As represented by reference 24 in FIG. 1, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 1, the CTU 14 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning. One can note that rectangular CU is a new feature of VVC that was not available in AVC and HEVC.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 1, a CU of size 2N×2N, can be divided in PU 2411 of size N×2N or of size 2N×N. In addition, said CU can be divided in “4” TU 2412 of size N×N or in “16” TU of size

$$( \frac{N}{2} ) \times ( \frac{N}{2} ) .$$

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “subpicture”, “slice” and “frame” may be used interchangeably. Usually, but not necessarily, the term “reconstructed” is used at the encoder side while “decoded” is used at the decoder side.

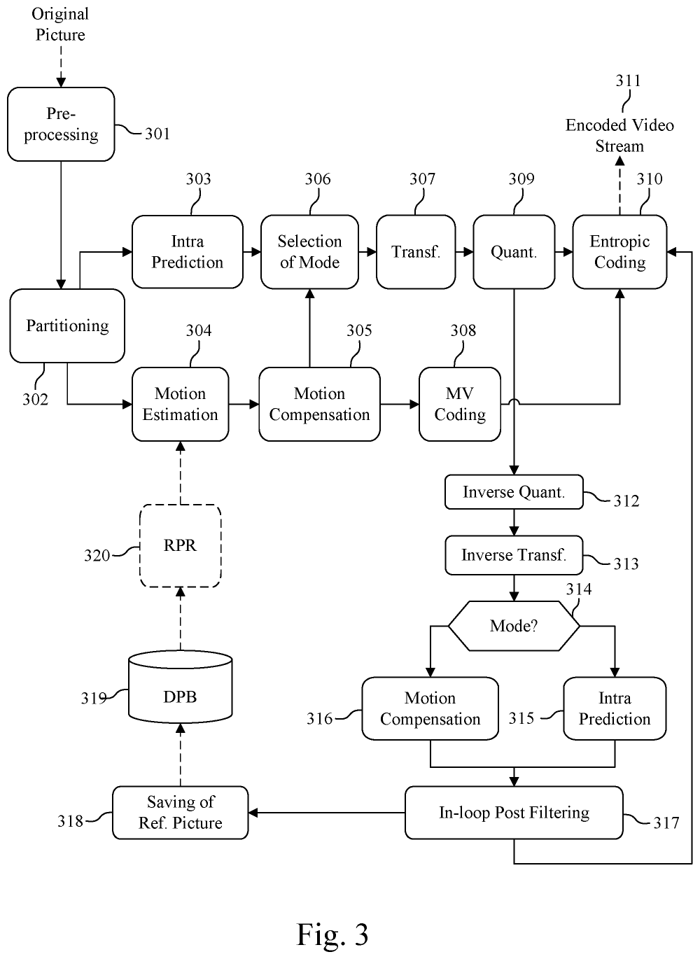

FIG. 3 depicts schematically a method for encoding a video stream executed by an encoding module. Variations of this method for encoding are contemplated, but the method for encoding of FIG. 3 is described below for purposes of clarity without describing all expected variations.

Before being encoded, a current original image of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). In addition, the pre-processing 301 may comprise a resampling (a down-sampling or an up-sampling). The resampling may be applied to some pictures so that the generated bitstream may comprise pictures at the original resolution and picture at another resolution (or at least pictures at at least two different resolutions). The resampling consists generally in a down-sampling and is used to reduce the bitrate of the generated bitstream. Nevertheless, up-sampling is also possible. Pictures obtained by pre-processing are called pre-processed pictures in the following.

The encoding of the pre-processed pictures begins with a partitioning of the pre-processed picture during a step 302, as described in relation to FIG. 1. The pre-processed picture is thus partitioned into CTU, CU, PU, TU, etc. For each block, the encoding module determines a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction direction indicating which pixels of the blocks in the vicinity to use, and a residual block resulting from a calculation of a difference between the current block and the prediction block. Recently, new intra prediction mode were proposed and introduced in VVC. These new intra prediction modes comprises
MIP (Matrix weighted Intra Prediction) consisting in using a matrix for generating an intra predictor from reconstructed neighbouring boundary samples on the left and above the block to predict;
ISP (Intra Sub-Partitions) dividing luma intra-predicted blocks vertically or horizontally into 2 or 4 sub-partitions depending on the block size;
CCLM (Cross-component linear model) prediction wherein the chroma samples of a CU are predicted based on the reconstructed luma samples of the same CU by using a linear model;
IBC (Intra Block Copy) consisting in predicting a block in a picture from another block of the same picture; and,
Reference samples filtering in intra area consisting in filtering reference samples used for intra prediction.

The inter prediction consists of predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. The motion estimation is generally performed at a sub-pixel precision, i.e. current and reference pictures are interpolated. In most recent video standards, the interpolation depends on the phase (sub-pixel position) of the interpolation used for the temporal prediction. For example, in the case of VVC, the interpolation is defined for phase 0 (samples are directly interpolated from their position (corresponding to integer-pixel interpolation)), or for phases larger than 0 (corresponding to sub-pixel interpolation). When sub-pixel interpolation is applied, luma uses “15” sub-pixel phases and a 8-tap poly-phase filter, and chroma uses “31” sub-pixel phases and a 4-tap poly-phase filter. Three cases are therefore to be considered: integer-interpolation, sub-pixel interpolation in the horizontal or vertical direction, sub-pixel interpolation in the horizontal and vertical directions. The motion vector determined by the motion estimation is used during a motion compensation step 305 during which a residual block is calculated in the form of a difference between the current block and the reference block. In first video compression standards, the mono-directional inter prediction mode described above was the only inter mode available. As video compression standards evolve, the family of inter modes has grown significantly and comprises now many different inter modes. These inter prediction modes comprises for example:
DMVR (decoder side motion vector refinement) wherein, in bi-prediction, a refined motion vector is searched around each initial motion vector. The refinement is performed symmetrically by the encoder and the decoder.
BDOF (bi-directional optical flow) which is based on the optical flow concept, which assumes that the motion of an object is smooth. BDOF is used to refine the bi-prediction signal of a CU at the 4×4 subblock level. BDOF is only applied to the luma component.
PROF (prediction refinement with optical flow): Subblock based affine motion compensation can save memory access bandwidth and reduce computation complexity compared to pixel based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation.
CIIP (Combined inter and intra prediction) which combines an inter prediction signal with an intra prediction signal.
GPM (geometric partitioning mode) which splits a CU into two parts by a geometrically located straight line. Each part of a geometric partition in the CU is inter-predicted using its own motion; only uni-prediction is allowed for each partition.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307 and quantized during a step 309. Transformation has also evolved and new tools were recently proposed. These new tools comprises:
JCCR (Joint coding of chroma residuals) where the chroma residuals are coded jointly.
MTS (multiple transform selection) where a selection is performed between a DCT-2, a DST-7 and a DCT-8 for horizontal and vertical transforms.
LFNST (Low-frequency non-separable transform): LFNST is applied between forward primary transform and quantization (at encoder) and between de-quantization and inverse primary transform (at decoder side). A 4×4 non-separable transform or a 8×8 non-separable transform is applied according to block size.
BDPCM (Block differential pulse coded modulation). BDPCM can be viewed as a competitor of the regular intra mode. When BDPCM is used, a BDPCM prediction direction flag is transmitted to indicate whether the prediction is horizontal or vertical. Then, the block is predicted using the regular horizontal or vertical intra prediction process with unfiltered reference samples. The residual is quantized and the difference between each quantized residual and its predictor, i.e. the previously coded residual of the horizontal or vertical (depending on the BDPCM prediction direction) neighbouring position, is coded.
SBT (Subblock transform) in which only a sub-part of the residual block is coded for the CU.

Note that the encoding module can skip the transform and apply quantization directly to the non-transformed residual signal. When the current block is coded according to an intra prediction mode, a prediction direction and the transformed and quantized residual block are encoded by an entropic encoder during a step 310. When the current block is encoded according to an inter prediction, when appropriate, a motion vector of the block is predicted from a prediction vector selected from a set of motion vectors corresponding to reconstructed blocks situated in the vicinity of the block to be coded. The motion information is next encoded by the entropic encoder during step 310 in the form of a motion residual and an index for identifying the prediction vector. The transformed and quantized residual block is encoded by the entropic encoder during step 310. Note that the encoding module can bypass both transform and quantization, i.e., the entropic encoding is applied on the residual without the application of the transform or quantization processes. The result of the entropic encoding is inserted in an encoded video stream 311.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the prediction direction corresponding to the current block is used for reconstructing the reference block of the current block. The reference block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference images as the encoder and thus avoid a drift between the encoding and the decoding processes. As mentioned earlier, in-loop filtering tools comprises deblocking filtering, SAO (Sample Adaptive Offset), ALF (Adaptive Loop Filter) and CC-ALF (Cross Component ALF). CC-ALF uses luma sample values to refine each chroma component by applying an adaptive, linear filter to the luma channel and then using the output of this filtering operation for chroma refinement. A new tool called LMCS (Luma Mapping with Chroma Scaling) can be also considered as an in-loop filtering. LMCS is added as a new processing block before the other loop-filters. LMCS has two main components: in-loop mapping of the luma component based on adaptive piecewise linear models; for the chroma components, luma-dependent chroma residual scaling is applied.

When a block is reconstructed, it is inserted during a step 318 into a reconstructed picture stored in a memory 319 of reconstructed images corresponding generally called Decoded Picture Buffer (DPB). The reconstructed images thus stored can then serve as reference images for other images to be coded.

A new tool of VVC, called Reference Picture Resampling (RPR), allows changing the resolution of coded pictures on the fly. The pictures are stored in the DPB, at their actual coded/decoded resolution, which may be lower that the video spatial resolution signaled in high-level syntax (HLS) of the bitstream. When a picture being coded at a given resolution uses for temporal prediction a reference picture that is not at the same resolution, a reference picture resampling of the texture is applied so that the predicted picture and the reference picture have the same resolution (represented by step 320 in FIG. 3). Note that depending on the implementation, the resampling process is not necessarily applied to the entire reference picture (entire reference picture resampling) but can be applied only to blocks identified as reference blocks when performing the decoding and reconstruction of the current picture (block-based reference picture resampling). In this case, when a current block in the current picture uses a reference picture that has a different resolution than the current picture, the samples in the reference picture that are used for the temporal prediction of the current block are resampled according to resampling ratios computed as ratios between the current picture resolution and the reference picture resolution.

Metadata such as SEI (supplemental enhancement information) messages can be attached to the encoded video stream 311. A SEI (Supplemental Enhancement Information) message as defined for example in standards such as AVC, HEVC or VVC is a data container or data structure associated to a video stream and comprising metadata providing information relative to the video stream.

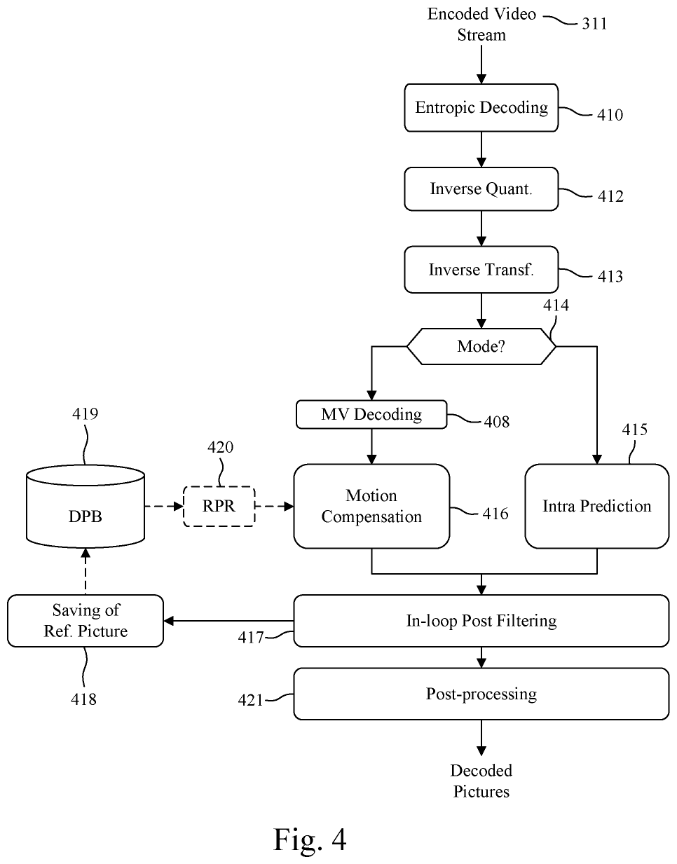

FIG. 4 depicts schematically a method for decoding the encoded video stream 311 encoded according to method described in relation to FIG. 3 executed by a decoding module. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain the prediction mode of the block.

If the block has been encoded according to an inter prediction mode, the entropic decoding allows to obtain, when appropriate, a prediction vector index, a motion residual and a residual block. During a step 408, a motion vector is reconstructed for the current block using the prediction vector index and the motion residual.

If the block has been encoded according to an intra prediction mode, entropic decoding allows to obtain a prediction direction and a residual block. Steps 412, 413, 414, 415, 416 and 417 implemented by the decoding module are in all respects identical respectively to steps 412, 413, 414, 415, 416 and 417 implemented by the encoding module. Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given image. The decoded picture can also be outputted by the decoding module for instance to be displayed. When RPR is activated, samples of (i.e. at least a portion of) the picture used as reference pictures are resampled in step 420 to the resolution of the predicted picture. The resampling step (420) and motion compensation step (416) can be in some implementations combined in one single sample interpolation step.

The decoded image can further go through post-processing in step 421. The post-processing can comprise an inverse color transform (e.g. conversion from YCbCr 4:2:0 to RGB 4:4:4), an inverse mapping performing the inverse of the remapping process performed in the pre-processing of step 301, a post-filtering for improving the reconstructed pictures based for example on filter parameters provided in a SEI message and/or a resampling for example for adjusting the output images to display constraints.

As already mentioned above, the standard ISO/IEC 23001-11 Energy-Efficient Media Consumption (Green Metadata) specifies metadata aiming at signaling complexity information or metrics (CMs) for different processes of a video distribution chain (encoding, adaptive streaming, decoding, displaying). The CMs are therefore representative of an energy consumption induced by said different processes. Regarding the decoder side, the complexity information is given for different decoding modules (DMs): entropy decoding, dequantization and inverse transform, intra prediction, motion compensation, deblocking, and side-information preparation. This information can be used by the decoder to set its CPU frequency at the lowest frequency that guarantees decoding completion within frame-rate deadlines and therefore potentially provides power reduction.

In the existing green MPEG, the CMs are signaled per period. The period type (indicated by a syntax element period_type) is either a single picture, a group of pictures (GOP), or a time interval. The CMs are made of the following information:
Proportion of blocks of size 8×8, 16×16 and 32×32, respectively, being in non-zero areas. This information impacts the entropy decoding, inverse quantization and inverse transform processes.
Proportion of intra blocks, and for those intra blocks, proportion of blocks being coded according to specific intra modes (planar, DC, angular horizontal/vertical). This information impacts the intra blocks decoding process.
For inter blocks, proportion of blocks using motion compensation for different sub-sample positions. This information impacts the motion compensation process.
Proportion of blocks using the deblocking filtering.

Below is the SEI message defined for HEVC (Table TAB1) for transporting CMs. The word “portion” indicates that ratios about the usage of coding tools/configurations are signaled in the SEI message. These “usage ratios” are computed by the encoder and exploited by the decoder to better control its energy consumption.

TABLE TAB1

```
green_metadata( payload_size )
green_metadata_type
switch (green_metadata_type ) {
  case 0:
  period_type
  if ( period_type == 2 ) {
    num_seconds
  }
  else if ( period_type == 3 ) {
    num_pictures
  }
  if ( period_type <= 3 ) {
    portion_non_zero_blocks_area
    if (portion_non_zero_blocks_area != 0 ) {
    portion_8x8_blocks_in_non_zero_area
    portion_16x16_blocks_in_non_zero_area
    portion_32x32_blocks_in_non_zero_area
    }
    portion_intra_predicted_blocks_area
    if (portion_intra_predicted_blocks_area == 255 ) {
    portion_planar_blocks_in_intra_area
    portion_dc_blocks_in_intra_area
    portion_angular_hv_blocks_in_intra_area
    }
    else {
    portion_blocks_a_c_d_n_filterings
    portion_blocks_h_b_filterings
    portion_blocks_f_i_k_q_filterings
    portion_blocks_j_filterings
    portion_blocks_e_g_p_r_filterings
    }
    portion_deblocking_instances
  }
  else if( period_type == 4 ) {
    max_num_slices_tiles_minus1
    for (t=0; t<=max_num_slices_tiles_minus1; t++ ) {
      first_ctb_in_slice_or_tile[t]
      portion_non_zero_blocks_area[t]
      if (portion_non_zero_blocks_area[t] != 0 ) {
      portion_8x8_blocks_in_non_zero_area[t]
      portion_16x16_blocks_in_non_zero_area[t]
      portion_32x32_blocks_in_non_zero_area[t]
      }
      portion_intra_predicted_blocks_area[t]
      if (portion_intra_predicted_blocks_area[t] == 255 ) {
      portion_planar_blocks_in_intra_area[t]
      portion_dc_blocks_in_intra_area[t]
      portion_angular_hv_blocks_in_intra_area[t]
      }
      else {
      portion_blocks_a_c_d_n_filterings[t]
      portion_blocks_h_b_filterings[t]
      portion_blocks_f_i_k_q_filterings[t]
      portion_blocks_j_filterings[t]
      portion_blocks_e_g_p_r_filterings[t]
      }
      portion_deblocking_instances[t]
    }
  }
  break;
  case 1:
    xsd_metric_type
    xsd_metric_value
    break;
  default:
}
```

The signaling of the usage ratios can be made according to different types of pictures sets, defined by the syntax element period_type. For HEVC, period_type is defined as follows (Table TAB2):

TABLE TAB2

| Period_type | |
|---|---|
| value | Description |
| 0 | complexity metrics are applicable to a single picture |
| 1 | complexity metrics are applicable to all pictures in decoding |
| | order, up to (but not including) the picture containing the |
| | next I slice |
| 2 | complexity metrics are applicable over a specified time |
| | interval in seconds |
| 3 | complexity metrics are applicable over a specified number |
| | of pictures counted in decoding order |
| 4 | complexity metrics are applicable to a single picture with |
| | slice or tile granularity |
| 5 | reserved |

The SEI message of Table TAB1 was originally designed for AVC and HEVC. As seen above, many new tools and features introduced in VVC are not considered. Various of the following embodiments describe adaptations of the SEI message of table TAB1 allowing considering new tools and features adopted in VVC.

FIG. 1A describes an example of a context in which following embodiments can be implemented.

In FIG. 1A, an apparatus 10, that could be a camera, a storage device, a computer, a server or any device capable of delivering a video stream, transmits a video stream to a system 12 using a communication channel 11. The video stream is either encoded and transmitted by the apparatus 10 or received and/or stored by the apparatus 10 and then transmitted. The communication channel 11 is a wired (for example Internet or Ethernet) or a wireless (for example WiFi, 3G, 4G or 5G) network link.

The apparatus 10 comprises an encoding module 100 compliant with the encoding method described in relation to FIG. 3. The system 12 comprise, for example, a decoding module 120 and a display device 121. The decoding module 120 is compliant with the method described in relation to FIG. 4.

FIG. 1B illustrates an example of process in which various embodiments can be implemented.

In a step 101, the apparatus 10 obtains a sequence of pictures to encode.

In a step 102, the encoding module 100 of the apparatus 10 encodes the sequence of pictures in the form of a bitstream applying the method of FIG. 3. In parallel to the encoding, the encoding module 100 computes CMs corresponding to encoding tools and features implemented by the method of FIG. 3 and signals these CMs in at least one SEI message.

In a step 103, the apparatus 10 associates the at least one SEI message to the bitstream and transmits the bitstream and the associated SEI message(s) to the system 12. The SEI messages are for example transported in a VVC NAL (Network Abstraction Layer) units.

In a step 104, the system 12 receives the bitstream.

In a step 105, the decoding module 120 recognizes the VVC NAL units transporting SEI messages, decodes the SEI messages and obtains the CMs.

In a step 106, the decoding module 120 adjust its decoding parameters in function of the decoded CMs. For instance, it adjusts its CPU frequency to the minimum value allowing decoding the pictures in real time.

In a step 107, the decoding module 120, with its adjusted parameters, decodes the pictures.

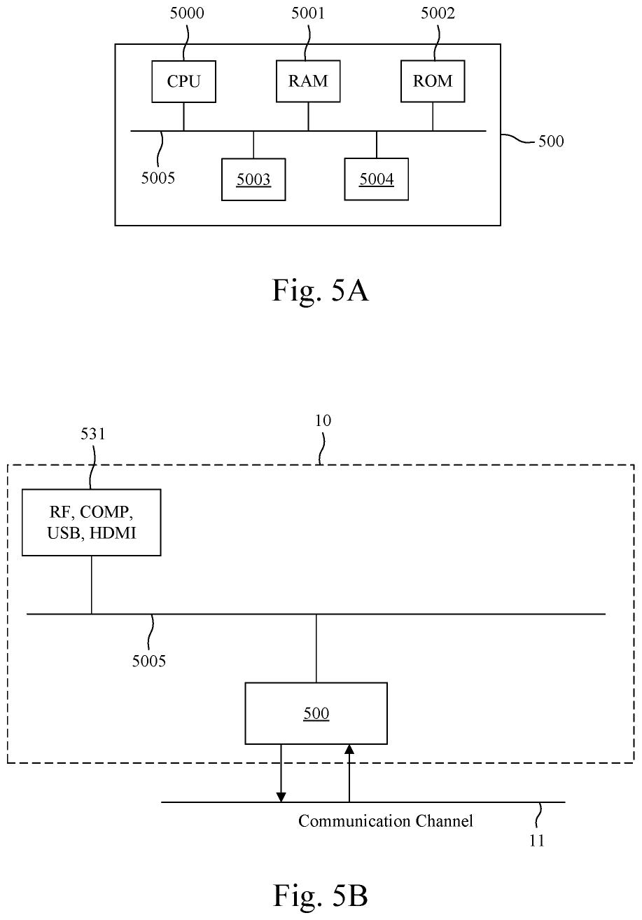

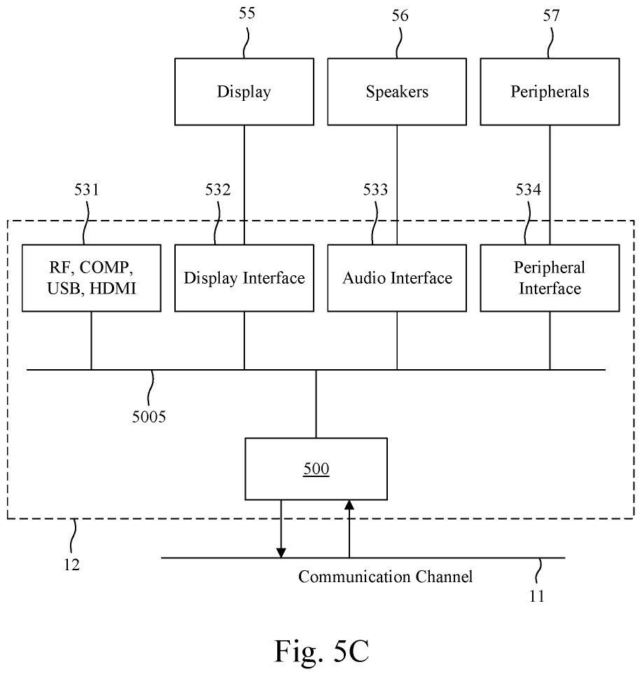

FIG. 5A illustrates schematically an example of hardware architecture of a processing module 500 able to implement the encoding module 100 or the decoding module 120 capable of implementing respectively the method for encoding of FIG. 3 and the method for decoding of FIG. 4 modified according to different aspects and embodiments or parts of the process of FIG. 1B related to the apparatus 10 or related to the system 12. The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or equipment. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and/or a SEI message and to provide a sequence of decoded pictures based on the SEI message. If the processing module 500 implements an encoding module, the communication interface 5004 enables for instance the processing module 500 to receive a sequence of original picture data to encode and to provide an encoded video stream and an associated SEI message.

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4 or an encoding method described in relation to FIG. 3, or part of the process described in relation to FIG. 1B, the decoding and encoding methods and the process comprising various aspects and embodiments described below in this document.

All or some of the algorithms and steps of said encoding or decoding methods may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

FIG. 5C illustrates a block diagram of an example of the system 12 in which various aspects and embodiments are implemented. The system 12 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 12, singly or in combination, can be embodied in a single integrated circuit (IC), multiple ICs, and/or discrete components. For example, in at least one embodiment, the system 12 comprises one processing module 500 that implements a decoding module. In various embodiments, the system 12 is communicatively coupled to one or more other systems, or other electronic devices, via, for example, a communications bus or through dedicated input and/or output ports. In various embodiments, the system 12 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5C, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 12 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 12 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 12, the processing module 500 is interconnected to other elements of said system 12 by the bus 5005.

The communication interface 5004 of the processing module 500 allows the system 12 to communicate on the communication channel 11. As already mentioned above, the communication channel 11 can be implemented, for example, within a wired and/or a wireless medium.

Data is streamed, or otherwise provided, to the system 12, in various embodiments, using a wireless network such as a Wi-Fi network, for example IEEE 802.11 (IEEE refers to the Institute of Electrical and Electronics Engineers). The Wi-Fi signal of these embodiments is received over the communications channel 11 and the communications interface 5004 which are adapted for Wi-Fi communications. The communications channel 11 of these embodiments is typically connected to an access point or router that provides access to external networks including the Internet for allowing streaming applications and other over-the-top communications. Other embodiments provide streamed data to the system 12 using the RF connection of the input block 531. As indicated above, various embodiments provide data in a non-streaming manner. Additionally, various embodiments use wireless networks other than Wi-Fi, for example a cellular network or a Bluetooth network.

The system 12 can provide an output signal to various output devices, including a display system 55, speakers 56, and other peripheral devices 57. The display system 55 of various embodiments includes one or more of, for example, a touchscreen display, an organic light-emitting diode (OLED) display, a curved display, and/or a foldable display. The display 55 can be for a television, a tablet, a laptop, a cell phone (mobile phone), a head mounted display or other devices. The display system 55 can also be integrated with other components, as in FIG. 1A (for example, as in a smart phone), or separate (for example, an external monitor for a laptop). The other peripheral devices 57 include, in various examples of embodiments, one or more of a stand-alone digital video disc (or digital versatile disc) (DVR, for both terms), a disk player, a stereo system, and/or a lighting system. Various embodiments use one or more peripheral devices 57 that provide a function based on the output of the system 12. For example, a disk player performs the function of playing an output of the system 12.

In various embodiments, control signals are communicated between the system 12 and the display system 55, speakers 56, or other peripheral devices 57 using signaling such as AV.Link, Consumer Electronics Control (CEC), or other communications protocols that enable device-to-device control with or without user intervention. The output devices can be communicatively coupled to system 12 via dedicated connections through respective interfaces 532, 533, and 534. Alternatively, the output devices can be connected to system 12 using the communications channel 11 via the communications interface 5004 or a dedicated communication channel via the communication interface 5004. The display system 55 and speakers 56 can be integrated in a single unit with the other components of system 12 in an electronic device such as, for example, a television. In various embodiments, the display interface 532 includes a display driver, such as, for example, a timing controller (T Con) chip.

The display system 55 and speaker 56 can alternatively be separate from one or more of the other components. In various embodiments in which the display system 55 and speakers 56 are external components, the output signal can be provided via dedicated output connections, including, for example, HDMI ports, USB ports, or COMP outputs.

FIG. 5B illustrates a block diagram of an example of the apparatus 10 in which various aspects and embodiments are implemented. Apparatus 10 is very similar to system 12. The apparatus 10 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of apparatus 10, singly or in combination, can be embodied in a single integrated circuit (IC), multiple ICs, and/or discrete components. For example, in at least one embodiment, the apparatus 10 comprises one processing module 500 that implements an encoding module. In various embodiments, the apparatus 10 is communicatively coupled to one or more other systems, or other electronic devices, via, for example, a communications bus or through dedicated input and/or output ports. In various embodiments, the apparatus 10 is configured to implement one or more of the aspects described in this document.

The input to the processing module 500 can be provided through various input modules as indicated in block 531 already described in relation to FIG. 5C.

Various elements of apparatus 10 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the apparatus 10, the processing module 500 is interconnected to other elements of said apparatus 10 by the bus 5005.

The communication interface 5004 of the processing module 500 allows the system 500 to communicate on the communication channel 11.

Data is streamed, or otherwise provided, to the apparatus 10, in various embodiments, using a wireless network such as a Wi-Fi network, for example IEEE 802.11 (IEEE refers to the Institute of Electrical and Electronics Engineers). The Wi-Fi signal of these embodiments is received over the communications channel 11 and the communications interface 5004 which are adapted for Wi-Fi communications. The communications channel 11 of these embodiments is typically connected to an access point or router that provides access to external networks including the Internet for allowing streaming applications and other over-the-top communications. Other embodiments provide streamed data to the apparatus 10 using the RF connection of the input block 531.

As indicated above, various embodiments provide data in a non-streaming manner. Additionally, various embodiments use wireless networks other than Wi-Fi, for example a cellular network or a Bluetooth network.

The data provided are raw data provided by a picture and/or audio acquisition module connected to the apparatus 10 or comprised in the apparatus 10.

The apparatus 10 can provide an output signal to various output devices capable of storing and/or decoding the output signal such as the system 12.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for determining a CPU frequency for performing the decoding.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for generating an SEI message comprising CMs.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream and SEI messages of a described embodiment. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

A first embodiment focuses on providing CMs adapted to RPR in the green MPEG metadata.

In existing green MPEG, many syntax elements defined for AVC and HEVC are based on a picture size, which is constant over the sequence referring to a size signaled in a picture header (picture parameter set (PPS)). Usage ratios of different coding modes are indicated relative to this picture size. This is for example used to determine a total number of 4×4 blocks processed in a period, defined in the green MPEG specification by a parameter TotalNum4×4BlocksInPeriod.

In addition, for some decoder features supporting several modes m1 to mN, ratios are generally reported for modes m1 to mN−1, and ratio for mode mN is deduced from the other ratios as ratio_mN=255−ratio_m1− . . . −ratio mN−1 (ratios are represented in fixed-point, using amplitude of 255, which corresponds to a ratio of 100%).

Due to the variation of picture size allowed by RPR, the way to report usage ratio of the various modes of existing green MPEG is no more adapted to VVC.

In a first variant of the first embodiment, the various ratios are defined by considering as reference picture size the maximum picture size of the bitstream as signaled for example in a sequence header (Sequence Parameter Set (SPS)), via parameters sps_pic_width_max_in_luma_samples and sps_pic_height_max_in_luma_samples, instead of using the decoded picture size. The various ratios (i.e. the CMs=the information representative of an energy consumption) depends on a single reference picture size defined for a sequence of picture in a sequence header (i.e; the SPS).

The reference picture size is defined by a parameter maxPicSizeInCtbsY, defined as follows:

maxPicSizeInCtbsY=maxPicWidthInCtbsY*maxPicHeightInCtbsY

with maxPicWidthInCtbsY and maxPicheightInCtbsY defined as follows:

maxPicWidthInCtbsY=(sps_pic_width_max_in_luma_samples+CtbSizeY−1)/CtbSizeY

maxPicHeightInCtbsY=(sps_pic_height_max_in_luma_samples+CtbSizeY−1)/CtbSizeY

where CtbSizeY is defined as the size of the luma Coding Tree Blocks (maximum block size).

As a consequence, the sum of usage ratios for the different modes of a feature may be lower than 255 (100%), for instance if one of several pictures are not coded at the maximum picture resolution signaled in the SPS. One consequence is that the usage ratio for all modes of a feature are reported explicitly. Indeed, in that case the usage ratio of one mode cannot be deduced from other modes. In the example mentioned above, usage ratios are specified for all modes m1 to mN, instead of modes m1 to mN−1 as done in the existing green MPEG specification for AVC and HEVC.

Referring to the example of the parameter TotalNum4×4BlocksPic defined in the existing green MPEG specification, in the first variant of the first embodiment, the parameter TotalNum4×4BlocksPic is now derived as follows

TotalNum4×4BlocksPic=maxPicSizeInCtbsY*(1<<(Ctb Log 2SizeY−2))²

where CtbLog 2SizeY defines the log 2 of the CTB size (e.g. equal to 2 for CTB size 16×16, equal to 3 for CTB size 32×32, equal to 4 for CTB size 64×64, equal to 5 for CTB size 128×128). Alternatively, the variable can be renamed TotalNum16BlocksPic, referring to blocks comprising 16 samples.

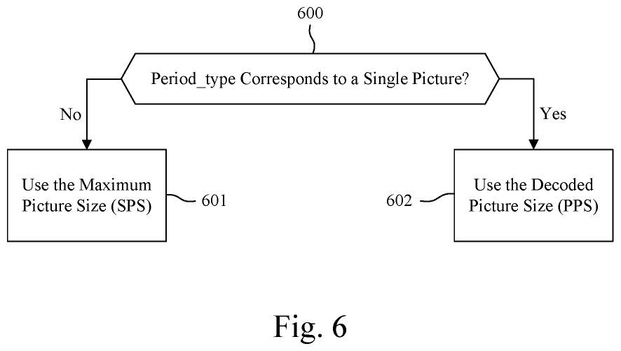

A second variant of the first embodiment illustrated in FIG. 6 is implemented by the processing module 500 when the processing module 500 implements the decoding module 120.

In a step 600, the processing module 500 determines if a syntax element period_type indicates that the reporting of a usage (i.e. of CMs) is made for a single picture or not.

With the syntax element period_type indicating that the reporting of the usage is made for a single picture, in a step 602, the processing module 500 specifies that the decoded picture size as signaled in the PPS is used (for example, for computing the parameter TotalNum4×4BlocksPic).

With the syntax element period_type indicating that the usage reporting is made for several pictures, in a step 601, the processing module specifies that the maximum picture size as signaled in the SPS is used (for example, for computing the parameter TotalNum4×4BlocksPic). This second variant allows keeping the maximum precision for reporting the usage ratios.

In this second variant, the various ratios (i.e. the CMS=the information representative of an energy consumption) depends on a single reference picture size define for a sequence of picture in a sequence header (i.e. the SPS) when various ratios are signaled for several pictures.

In a third variant of the first embodiment, the total number of 4×4 blocks TotalNum4×4BlocksInPeriod is signaled explicitly in the SEI message by a syntax element total_number_4×4_blocks_in_period. Hence there is no need to check the picture size of the different pictures in a considered period, a period being defined as a subset of consecutive pictures of a video stream.

If the total number of 4×4 blocks TotalNum4×4BlocksInPeriod is coded as is, it is considered that “26” bits are large enough to indicate its value for 8K pictures, and for a segment of “128” pictures (typically for “120” fps videos). For easier byte-alignments, “32” bits is therefore recommended for the syntax element total_number_4×4_blocks_in_period.

If using less bits is preferable, this can be reduced to “16” bits. It is possible in such a case to quantize the value of the total number of 4×4 blocks TotalNum4×4BlocksInPeriod, for instance by a factor “1024” (2¹⁰), the actual total number of 4×4 blocks being:

TotalNum4×4BlocksInPeriod=1024*total_number_4×4_blocks_in_period.

In another variant, to avoid too large values of the total number of 4×4 blocks TotalNum4×4BlocksInPeriod exceeding “32” bits, the syntax element total_number_4×4_blocks_in_period is set to:
a value depending on a threshold numSecondsMax when a syntax element num_seconds of the SEI message indicating a number of seconds over which the CMs are applicable when period_type is 2 is larger than a given threshold numSecondsMax (typically numSecondsMax=1); or,
a value depending on a threshold numPicturesMax when a syntax element num_pictures of the SEI message specifying a number of pictures, counted in decoding order, over which the complexity metrics are applicable when period_type is 3 is larger than a given threshold numPicturesMax (typically set to the number of frames per second of the coded video content).

This leads to the following semantics (in bold in the following) for the syntax element total_number_4×4_blocks_in_period:
[symbol] specifies the total number of 4×4 blocks (or blocks comprising 16 samples) that are coded in the specified period. The parameter [symbol] is derived as follows:
   [symbol] is set equal to [symbol]
   When the following conditions are true, [symbol] is set equal to ( [symbol] × [symbol] + [symbol] /2) [symbol] :
      [symbol] is equal to “2”;
      [symbol] is greater than [symbol] .
   When the following conditions are true, [symbol] is set equal to ( [symbol] × [symbol] + [symbol] /2) [symbol]
      [symbol] is equal to “3”;
      [symbol] is greater than [symbol] .

In a variant, blocks of smaller size than 4×4 or 16 samples are considered as reference size. For instance, the reference size is 2×2, as this is the minimum size for chroma blocks. The corresponding syntax element is then defined as [symbol] . Nevertheless, it is generally considered that blocks of 4 samples are overall of small proportion and do not significantly impact the overall decoder complexity. In addition, they can be counted and added to the number of blocks 4×4, each of them contributing as ¼=0.25 to this numbering. The same concept can apply for other block sizes smaller than 4×4 or 16 samples.

A second embodiment focuses on providing CMs adapted to rectangular blocks in the green MPEG metadata.

The usage ratio (i.e. the CMS=the information representative of an energy consumption) for a given mode reported by a given syntax element is in some cases based on a concatenation of usage ratios for all various block sizes using the mode. As in VVC blocks can be rectangular, it is preferable to consider the number of samples per square and rectangular blocks, instead of considering the square blocks width/height as done in the existing green MPEG specification. For instance, for blocks sizes from 4×4 to 64×64, instead of adding the usage for blocks 4×4, 8×8, 16×16, 32×32, 64×64 as currently done in the green MPEG specification for AVC and HEVC, the sum should be added for blocks with number of samples 16, 32, 64, 128, 256, 512, 1024, 2048, 4096, when these sizes are relevant.

In VVC, “3” transform types are supported, type “0” (corresponding to DCT-II), type “1” (corresponding to DST-VII), type “2” (corresponding to DCT-VIII). For a given block, either Type “0” is used for the transforms in both horizontal and vertical dimensions, or Type “1” and “2” can be used together for the transforms in both horizontal and vertical dimensions. Type “0” transform can be implemented using fast implementations such as butterfly implementations. On the other hand, type “1” and “2” cannot be implemented using such solutions, and involve matrix multiplications of the size of the transform. An example of text specification illustrating this second embodiment is provided below (in bold) for the usage of a transform type “0”. Equivalent text specification can be used for transform type “1” and “2”.

[symbol] indicates the portion of area covered by blocks using the transform of type “0” in the pictures of the specified period, using 4×4 granularity and is defined as follows:

$$= ( \frac{4 \times 4}{} \times 255 )$$

[symbol] is the number of blocks using the transform of type 0 in the specified period using 4×4 granularity. At the encoder side, it is computed as follows:

$$= + {2}^{*} + {4}^{*} + {8}^{*} + {16}^{*} + {32}^{*} + {64}^{*} + {128}^{*} + {256}^{*}$$

Where [symbol] are the number of blocks using transform type “0”, for number of samples from X=16, 32, 64, 128, 256, 512, 1024, 2048, 4096.

The factors 2, 4, . . . 256 in the formula correspond to the block sizes ratio relative the blocks of size 16. For instance, for blocks of size 32 (NumTrType0_32Blocks), the factor is 32/16=2. For blocks of size 4096 (NumTrType0_4096Blocks), the factor is 4096/16=256.

For instance, if the encoder derives NumTrType0_8Blocks and NumTrType0_4Blocks as the number of blocks comprising “8” and “4” samples, NumTrType0Blocks can be incremented by NumTrType0_8Blocks/2 or (NumTrType0_8Blocks+1)/2 and by NumTrType0_4Blocks/4 or (NumTrType0_4Blocks+2)/4.

A third embodiment focuses on providing CMs adapted to new features impacting the entropy decoding complexity in the green MPEG metadata.

In this third embodiment, the syntax elements specified for AVC and HEVC related to the amount of non-zero blocks, for different square block sizes, are now signaled for square and rectangular blocks of different number of samples. New syntax elements portion_X_blocks_in_non_zero_area are added, with X being a number of samples in the block (where X=16, 32, 64, 128, 256, 512, 1024, 2048 and 4096). One can note that the last value of X=4096 is introduced to consider blocks having a size equal to the maximum transform unit size of 64×64 defined in VVC.

The SBT mode, in which only a sub-part of the residual block is encoded, the remaining sub-part being set to zero, has also a direct impact on the entropy decoding. A new syntax element portion_sbt_blocks_in_non_zero_area related to the SBT mode is therefore added. The syntax element portion_sbt_blocks_in_non_zero_area indicates the relative usage of the sub-block transform (SBT) mode.

A fourth embodiment focuses on providing CMs adapted to new features impacting the inverse transform complexity in the green MPEG metadata.

In VVC, several new tools impact the complexity of the inverse transform: JCCR, MTS, LFNST and BDPCM. In the fourth embodiment new syntax elements are defined to address these new tools:
portion_jccr_blocks_area: this new syntax element is added to indicate the relative usage of the JCCR mode;
portion_trtype0_blocks_area: this new element is added to indicate the relative usage of transform type 0 (DCT2) in the MTS tool;
portion_trtype1_2_blocks_area: this syntax new element is added to indicate the relative usage of transform types “1” or “2” (respectively DST7 or DCT8) in the MTS tool;
portion_lfirst_blocks_area: this new syntax element is added to indicate the relative usage of the LFNST tool; it counts the areas in the pictures using LFNST of size 16×16 and 48×16;
portion_bdpcm_blocks_area: this new syntax element is added to indicate the relative usage of the BDPCM mode.

A fifth embodiment focuses on providing CMs adapted to new features impacting the intra prediction and the intra blocks decoding complexity in the green MPEG metadata.

New intra prediction tools such as MIP, ISP, CCLM, IBC and reference samples filtering in intra area have an impact on the decoding complexity. In the fifth embodiment new syntax elements are defined to address these new tools:
portion_mip_blocks_in_intra_area: this new syntax element is added to indicate the relative usage of the MIP mode;
portion_isp_blocks_in_intra_area: this new syntax element is added to indicate the relative usage of the ISP mode;
portion_cclm_blocks_in_intra_area: this new syntax element is added to indicate the relative usage of the CCLM mode;
portion_ibc_blocks_in_intra_area: this new syntax element is added to indicate the relative usage of the IBC mode;
ref_samples_filtering_in_intra_area: this new syntax element is added to indicate the relative usage of the reference samples filtering mode in intra prediction.

In a variant, as MIP uses matrices of different sizes depending on the block sizes, the syntax element portion_mip_blocks_in_intra_area can be reported for different block sizes. For instance the following syntax elements can be introduced:
portion_mip16×4_blocks_in_intra_area for 16×4 blocks;
portion_mip16×8_blocks_in_intra_area for 16×8 blocks;
portion_mip64×8_blocks_in_intra_area for 64×8 blocks.

Alternatively, the value of the syntax element portion_mip_blocks_in_intra_area can be computed from a parameter NumMipCodedBlocks from the different blocks sizes as follows:

NumMipCodedBlocks=4*NumMipCoded_16×4Blocks+8*NumMipCoded_16×8Blocks

The factors “4” and “8” correspond to the block sizes ratio relative the blocks of size “16”. For instance, for blocks of size 16×4 (NumMipCoded_16×4Blocks), the factor is 16×4/16=4. For blocks of size 16×4 (NumMipCoded_16×8Blocks), the factor is 16×8/16=8. The encoder computes the value of NumMipCodedBlocks, set portion_mip_blocks_in_intra_area equal to NumMipCodedBlocks, and signals portion_mip_blocks_in_intra_area in the stream.

A sixth embodiment focuses on providing CMs adapted to new features impacting the inter prediction and the inter blocks decoding complexity in the green MPEG metadata.

One feature impacting on the complexity of inter prediction is the fact that a block is predicted using a unidirectional prediction or a bidirectional prediction. This information is not reported in the existing green MPEG specification (i.e. for AVC and HEVC), although this has an important impact on the decoder complexity.

In the sixth embodiment new syntax elements are defined to address this feature:
portion_uni_predicted_blocks_area: this new syntax element is added to indicate the relative usage of unidirectional prediction in inter prediction;
portion_bi_predicted_blocks_area: this new syntax element is added to indicate the relative usage of bidirectional prediction in inter prediction.

In addition, new inter prediction modes also impacts the decoding complexity. In the seventh embodiment new syntax elements are defined to address these new modes:
portion_dmvr_blocks: this new syntax element is added to indicate the relative usage of the DMVR mode;
portion_bdof_blocks: this new syntax element is added to indicate the relative usage of the BDOF mode;
portion_prof_blocks: this new syntax element is added to indicate the relative usage of the PROF mode;
portion_ciip_blocks_area: this new syntax element is added to indicate the relative usage of the CIIP mode;
portion_gpm_blocks_area: this new syntax element is added to indicate the relative usage of the GPM mode.

A seventh embodiment focuses on providing CMs adapted to new features impacting the interpolation for temporal prediction complexity in the green MPEG metadata.

As seen above, motion estimation is generally performed with sub-pixel precision which require interpolating pictures. In the seventh embodiment, three syntax elements are defined to consider the three possible interpolation cases, i.e. integer-interpolation, sub-pixel interpolation in the horizontal or vertical direction, sub-pixel interpolation in the horizontal and vertical directions:
portion_integer_interpolation_blocks: this new syntax element is added to indicate the relative usage of integer-pixel interpolation for motion compensation;
portion_hor_or_ver_interpolation_blocks: this new syntax element is added to indicate the relative usage of sub-pixel interpolation in one of the horizontal or vertical directions for motion compensation;
portion_hor_and_ver_interpolation_blocks: this new syntax element is added to indicate the relative usage of sub-pixel interpolation in the horizontal and vertical directions for motion compensation.

A eighth embodiment focuses on providing CMs adapted to new features impacting the in-loop filtering complexity in the green MPEG metadata.

In VVC, three new in-loop filtering tools were introduced: ALF, CCALF and LMCS. In the eighth embodiment, three syntax elements are defined to consider these three tools:
portion_alf_instances: this new syntax element is added to indicate the relative usage of ALF mode;
portion_ccalf_instances: this new syntax element is added to indicate the relative usage of the CCALF mode;
portion_lmcs_instances: this new element is added to indicate the relative usage of the LMCS mode.

The following table TAB3 depicts the changes in the green MPEG SEI syntax induced by the above eight embodiments related to VVC, where changes compared to the existing green MPEG SEI syntax are indicated in bold.

TABLE TAB3

| | Size | |
|---|---|---|
| | (bits) | Descriptor |
| period type | 8 | unsigned integer |
| if ( period type == 2 ) { | | |
| num seconds | 16 | unsigned integer |
| } | | |
| else if ( period type == 3 ) { | | |
| num pictures | 16 | unsigned integer |
| } | | |
| total number 4x4 blocks in period | 32 | unsigned integer |
| if ( period type <= 3 ) { | | |
| portion non zero blocks area | 8 | unsigned integer |
| if ( portion non zero blocks area != 0 ) { | | |
| portion 64 blocks in non zero area | 8 | unsigned integer |
| portion 128 blocks in non zero area | 8 | unsigned integer |
| portion 256 blocks in non zero area | 8 | unsigned integer |
| portion 512 blocks in non zero area | 8 | unsigned integer |
| portion 1024 blocks in non zero area | 8 | unsigned integer |
| portion 2048 blocks in non zero area | 8 | unsigned integer |
| portion 4096 blocks in non zero area | 8 | unsigned integer |
| portion sbt blocks in non zero area | 8 | unsigned integer |
| } | | |
| portion jccr blocks area | 8 | unsigned integer |
| portion trtype0 blocks area | 8 | unsigned integer |
| portion trtype1 2 blocks area | 8 | unsigned integer |
| portion lfnst blocks area | 8 | unsigned integer |
| portion bdpcm blocks area | 8 | unsigned integer |
| portion intra predicted blocks area | 8 | unsigned integer |
| portion uni predicted blocks area | 8 | unsigned integer |
| portion bi predicted blocks area | 8 | unsigned integer |
| if ( portion intra predicted blocks area == 255 ) { | | |
| portion planar blocks in intra area | 8 | unsigned integer |
| portion dc blocks in intra area | 8 | unsigned integer |
| portion angular hv blocks in intra area | 8 | unsigned integer |
| portion mip blocks in intra area | 8 | unsigned integer |
| portion isp blocks in intra area | 8 | unsigned integer |
| portion cclm blocks in intra area | 8 | unsigned integer |
| portion ibc blocks in intra area | 8 | unsigned integer |
| portion ref samples filtering in intra area | 8 | unsigned integer |
| } | | |
| else { | | |
| portion integer interpolation blocks | 8 | unsigned integer |
| portion hor or ver interpolation blocks | 8 | unsigned integer |
| portion hor and ver interpolation blocks | 8 | unsigned integer |
| portion dmvr blocks | 8 | unsigned integer |
| portion bdof blocks | 8 | unsigned integer |
| portion prof blocks | 8 | unsigned integer |
| portion ciip blocks area | 8 | unsigned integer |
| portion gpm blocks area | 8 | unsigned integer |
| } | | |
| portion deblocking instances | 8 | unsigned integer |
| portion alf instances | 8 | unsigned integer |
| portion ccalf instances | 8 | unsigned integer |
| portion lmcs instances | 8 | unsigned integer |
| } | | |
| ... | | |

For the case of period_type equal to “4”, corresponding to a per-picture signaling with slice/tile/subpicture granularity, the same syntax changes are to be made in the syntax part, with index [t] added for each added syntax element, t indicating the slice/tile index as represented in table TAB3bis.

TABLE TAB3bis

| | Size | Descriptor |
|---|---|---|
| period type | 8 | unsigned integer |
| if ( period type == 2 ) { | | |
| num seconds | 16 | unsigned integer |
| } | | |
| else if ( period type == 3 ) { | | |
| num pictures | 16 | unsigned integer |
| } | | |
| total number 4x4 blocks in period | 32 | unsigned integer |
| if ( period type <= 3 ) { | | |
| portion non zero blocks area | 8 | unsigned integer |
| if ( portion non zero blocks area != 0 ) { | | |
| portion_{—}64_{—}blocks_{—}in_{—}non_{—}zero_{—}area | 8 | unsigned integer |
| portion_{—}128_{—}blocks_{—}in_{—}non_{—}zero_{—}area | 8 | unsigned integer |
| portion_{—}256_{—}blocks_{—}in_{—}non_{—}zero_{—}area | 8 | unsigned integer |
| portion_{—}512_{—}blocks_{—}in_{—}non_{—}zero_{—}area | 8 | unsigned integer |
| portion_{—}1024_{—}blocks_{—}in_{—}non_{—}zero_{—}area | 8 | unsigned integer |
| portion_{—}2048_{—}blocks_{—}in_{—}non_{—}zero_{—}area | 8 | unsigned integer |
| portion 4096 blocks in non zero area | 8 | unsigned integer |
| } | | |
| portion jccr blocks area | 8 | unsigned integer |
| portion trtype0 blocks area | 8 | unsigned integer |
| portion trtype1 2 blocks area | 8 | unsigned integer |
| portion lfnst blocks area | 8 | unsigned integer |
| portion intra predicted blocks area | 8 | unsigned integer |
| portion uni predicted blocks area | 8 | unsigned integer |
| portion bi predicted blocks area | 8 | unsigned integer |
| if ( portion intra predicted blocks area == 255 ) { | | |
| portion planar blocks in intra area | 8 | unsigned integer |
| portion dc blocks in intra area | 8 | unsigned integer |
| portion angular hv blocks in intra area | 8 | unsigned integer |
| portion mip blocks in intra area | 8 | unsigned integer |
| portion cclm blocks in intra area | 8 | unsigned integer |
| portion ibc blocks in intra area | 8 | unsigned integer |
| } | | |
| else { | | |
| portion integer interpolation blocks | 8 | unsigned integer |
| portion hor or ver interpolation blocks | 8 | unsigned integer |
| portion hor and ver interpolation blocks | 8 | unsigned integer |
| portion dmvr blocks | 8 | unsigned integer |
| portion bdof blocks | 8 | unsigned integer |
| portion prof blocks | 8 | unsigned integer |
| portion gpm blocks area | 8 | unsigned integer |
| } | | |
| portion deblocking instances | 8 | unsigned integer |
| portion alf instances | 8 | unsigned integer |
| portion ccalf instances | 8 | unsigned integer |
| portion lmcs instances | 8 | unsigned integer |
| } | | |
| if ( period type == 4 ) { | | |
| max num slices tiles subpictures minus1 | 16 | unsigned integer |
| for ( t=0; t<=max num slices tiles subpictures | | |
| first ctb in slice or tile or subpicture[t] | 16 | unsigned integer |
| portion non zero blocks area[t] | 8 | unsigned integer |
| if ( portion non zero blocks area[t] != 0 ) { | | |
| portion 64 blocks in non zero area[t] | 8 | unsigned integer |
| portion 128 blocks in non zero area[t] | 8 | unsigned integer |
| portion 256 blocks in non zero area[t] | 8 | unsigned integer |
| portion 512 blocks in non zero area[t] | 8 | unsigned integer |
| portion 1024 blocks in non zero area[t] | 8 | unsigned integer |
| portion 2048 blocks in non zero area[t] | 8 | unsigned integer |
| portion 4096 blocks in non zero area[t] | 8 | unsigned integer |
| } | | |
| portion jccr blocks area[t] | 8 | unsigned integer |
| portion trtype0 blocks area[t] | 8 | unsigned integer |
| portion trtype1 2 blocks area[t] | 8 | unsigned integer |
| portion lfnst blocks area[t] | 8 | unsigned integer |
| portion intra predicted blocks area[t] | 8 | unsigned integer |
| portion uni predicted blocks area[t] | 8 | unsigned integer |
| portion bi predicted blocks area[t] | 8 | unsigned integer |
| if ( portion intra predicted blocks area[t] == 255 ) { | | |
| portion planar blocks in intra area[t] | 8 | unsigned integer |
| portion dc blocks in intra area[t] | 8 | unsigned integer |
| portion angular hv blocks in intra area[t] | 8 | unsigned integer |
| portion mip blocks in intra area[t] | 8 | unsigned integer |
| portion cclm blocks in intra area[t] | 8 | unsigned integer |
| portion ibc blocks in intra area[t] | 8 | unsigned integer |
| } | | |
| else { | | |
| portion integer interpolation blocks[t] | 8 | unsigned integer |
| portion hor or ver interpolation blocks[t] | 8 | unsigned integer |
| portion hor and ver interpolation blocks[t] | 8 | unsigned integer |
| portion dmvr blocks[t] | 8 | unsigned integer |
| portion bdof blocks[t] | 8 | unsigned integer |
| portion prof blocks[t] | 8 | unsigned integer |
| portion gpm blocks area[t] | 8 | unsigned integer |
| } | | |
| portion deblocking instances[t] | 8 | unsigned integer |
| portion alf instances[t] | 8 | unsigned integer |
| portion ccalf instances[t] | 8 | unsigned integer |
| portion lmcs instances[t] | 8 | unsigned integer |
| } | | |
| } | | |

A ninth embodiment focuses on providing CMs adapted to a use of subpictures in the green MPEG metadata.

When subpictures are used in the VVC bitstream, the parameters signaled in the SEI are signaled per subpicture. Subpictures are used when a syntax element sps_num_subpics_minus1 in the VVC SPS is greater than “0”, sps_num_subpics_minus1 being representative of a number of subpictures in pictures.

Table TAB4 represents a modified version of table TAB2 in which a new entry is added for the case of subpictures enabled (value 5).

TABLE TAB4

| Period_type | |
|---|---|
| value | Description |
| 0 | complexity metrics are applicable to a single picture |
| 1 | complexity metrics are applicable to all pictures in decoding |
| | order, up to (but not including) the picture containing the |
| | next I slice |
| 2 | complexity metrics are applicable over a specified time |
| | interval in seconds |
| 3 | complexity metrics are applicable over a specified number |
| | of pictures counted in decoding order |
| 4 | complexity metrics are applicable to a single picture with |
| | slice or tile granularity |
| 5 | complexity metrics are applicable to a single picture |
| | with subpicture granularity |
| 6 | reserved |

In addition, the syntax elements of table TAB3 are duplicated for the subpicture case, by adding an equality check of the value of the syntax element period_type to 5 (if(period_type==5)). The syntax elements reporting usage ratios are indexed by an index [z] indicating the subpicture index. An illustration of some modifications induced by the ninth embodiment in table TAB3 is given in table TAB5.

TABLE TAB5

| | | |
|---|---|---|
| ... | | |
| else if ( period_{—}type == 5 ) { | | |
| max num subpictures minus1 | 16 | unsigned integer |
| for ( t=0; t<=max num subpictures minus1; t++ ) | | |
| { | | |
| first ctb in subpicture[t] | 16 | unsigned integer |
| portion non zero blocks area[t] | 8 | unsigned integer |
| if ( portion non zero blocks area[t] != 0 ) { | | |
| portion 64 blocks in non zero area[t] | 8 | unsigned integer |
| portion 128 blocks in non zero area[t] | 8 | unsigned integer |
| portion 256 blocks in non zero area[t] | 8 | unsigned integer |
| portion 512 blocks in non zero area[t] | 8 | unsigned integer |
| ... | | |

In a variant of the ninth embodiment, in case of subpictures granularity, the usage ratio parameters can also be signaled for a period of pictures. For instance by the following new values of period_type (6, 7, 8):

| Period_type | |
|---|---|
| value | Description |
| 0 | complexity metrics are applicable to a single picture |
| 1 | complexity metrics are applicable to all pictures in decoding |
| | order, up to (but not including) the picture containing the |
| | next I slice |
| 2 | complexity metrics are applicable over a specified time |
| | interval in seconds |
| 3 | complexity metrics are applicable over a specified number |
| | of pictures counted in decoding order |
| 4 | complexity metrics are applicable to a single picture with |
| | slice or tile granularity |
| 5 | complexity metrics are applicable to a single picture |
| | with subpicture granularity |
| 6 | complexity metrics are applicable to all pictures in |
| | decoding order, up to (but not including) the picture |
| | containing th enext I slice, and with subpicture |
| | granularity |
| 7 | complexity metrics are applicable over a specified time |
| | interval in seconds, and with subpicture granularity |
| 8 | complexity metrics are applicable over a specified number |
| | of pictures counted in decoding order, and with |
| | subpicture granularity |
| 6 | reserved |

In a variant of the ninth embodiment, the new period_type value (period_type=5) is not added to table TAB2, but the signaling in case of subpictures relies on the period_type value “4” (single picture with slices/tiles granularity). For subpictures, it is needed to identify the slices included in a subpicture. When decoding a subpicture, it is then possible to identify the slices contained by the subpicture, and to get the metadata from these slices. This can be done thanks to the syntax element sh_subpic_id that allows identifying the subpicture to which a slice belongs to.

In a tenth embodiment, as mentioned in steps 103 and 104 of FIG. 1B, the green MPEG SEI messages of TAB3 (or TAB3bis) are transported in VVC NAL units, a NAL (Network abstraction layer) unit being a data container. A NAL unit is identified by a NAL unit type which allow a decoder recognizing the type of data transported by the NAL unit. In the case of a green MPEG SEI message, the NAL unit type is set to PREFIX_SEI_NUT. Table TAB6 describes a syntax of a payload adapted for transporting green MPEG SEI message as described in tables TAB3.

```
TABLE TAB6
green_metadata( payload_size )
green_metadata_type
switch (green_metadata_type ) {
  case 0:
  period_type
  if ( period_type == 2 ) {
    num_seconds
  }
  else if ( period_type == 3 ) {
    num_pictures
  }
  total_{—}number_{—}4x4_{—}blocks_{—}in_{—}period
  if ( period_type <= 3 ) {
    portion_non_zero blocks area
    if (portion_non_zero_blocks_area != 0 ) {
      portion_{—}64_{—}blocks_{—}in_{—}non_{—}zero_{—}area
      portion_{—}128_{—}blocks_{—}in_{—}non_{—}zero_{—}area
      portion_{—}256_{—}blocks_{—}in_{—}non_{—}zero_{—}area
      portion_{—}512_{—}blocks_{—}in_{—}non_{—}zero_{—}area
      portion_{—}1024_{—}blocks_{—}in_{—}non_{—}zero_{—}area
      portion_{—}2048_{—}blocks_{—}in_{—}non_{—}zero_{—}area
      portion_{—}4096_{—}blocks_{—}in_{—}non_{—}zero_{—}area
    }
    portion_{—}jccr_{—}blocks_{—}area
    portion_{—}trtype0_{—}blocks_{—}area
    portion_{—}trtype1_{—}2_{—}blocks_{—}area
    portion_{—}lfnst_{—}blocks_{—}area
    portion_intra_predicted_blocks_area
    portion_{—}uni_{—}predicted_{—}blocks_{—}area
    portion_{—}bi_{—}predicted_{—}blocks_{—}area
    if (portion_intra_predicted_blocks_area == 255 ) {
      portion_planar_blocks_in_intra_area
      portion_dc_blocks_in_intra_area
      portion_angular_hv_blocks_in_intra_area
      portion_{—}mip_{—}blocks_{—}in_{—}intra_{—}area
      portion_{—}cclm_{—}blocks_{—}in_{—}intra_{—}area
      portion_{—}ibc_{—}blocks_{—}in_{—}intra_{—}area
    }
    else {
      portion_{—}integer_{—}interpolation_{—}blocks
      portion_{—}hor_{—}or_{—}ver_{—}interpolation_{—}blocks
      portion_{—}hor_{—}and_{—}ver_{—}interpolation_{—}blocks
      portion_{—}dmvr_{—}blocks
      portion_{—}bdof_{—}blocks
      portion_{—}prof_{—}blocks
      portion_{—}ciip_{—}blocks_{—}area
      portion_{—}gpm_{—}blocks_{—}area
    }
    portion_deblocking_instances
    portion_{—}alf_{—}instances
    portion_{—}ccalf_{—}instances
    portion_{—}lmcs_{—}instances
  }
  else if( period_type == 4 ∥ period_type == 5 ) {
    max_num_slices_tiles_subpictures_minus1
    for (t=0; t<=max_num_slices_tiles_subpictures_minus1; t++ ) {
      first_ctb_in_slice_or_tile_or_subpicture[t]
      portion_non_zero_blocks_area[t]
      if (portion_non_zero_blocks_area[t] != 0 ) {
        portion_{—}64_{—}blocks_{—}in_{—}non_{—}zero_{—}area[t]
        portion_{—}128_{—}blocks_{—}in_{—}non_{—}zero_{—}area[t]
        portion_{—}256_{—}blocks_{—}in_{—}non_{—}zero_{—}area[t]
        portion_{—}512_{—}blocks_{—}in_{—}non_{—}zero_{—}area[t]
        portion_{—}1024_{—}blocks_{—}in_{—}non_{—}zero_{—}area[t]
        portion_{—}2048_{—}blocks_{—}in_{—}non_{—}zero_{—}area[t]
        portion_{—}4096_{—}blocks_{—}in_{—}non_{—}zero_{—}area[t]
      }
      portion_{—}jccr_{—}blocks_{—}area[t]
      portion_{—}trtype0_{—}blocks_{—}area[t]
      portion_{—} trtype1_{—}2_{—}blocks_{—}area[t]
      portion_{—}lfnst_{—}blocks_{—}area[t]
      portion_intra_predicted_blocks_area[t]
      portion_{—}uni_{—}predicted_{—}blocks_{—}area[t]
      portion_{—}bi_{—}predicted_{—}blocks_{—}area[t]
      if (portion_intra_predicted_blocks_area[t] == 255 ) {
        portion_planar_blocks_in_intra_area[t]
        portion_dc_blocks_in_intra_area[t]
        portion_angular_hv_blocks_in_intra_area[t]
        portion_{—}mip_{—}blocks_{—}in_{—}intra_{—}area[t]
        portion_{—}cclm_{—}blocks_{—}in_{—}intra_{—}area[t]
        portion_{—}ibc_{—}blocks_{—}in_{—}intra_{—}area[t]
      }
      else {
        portion_{—}integer_{—}interpolation_{—}blocks[t]
        portion_{—}hor_{—}or_{—}ver_{—}interpolation_{—}blocks[t]
        portion_{—}hor_{—}and_{—}ver_{—}interpolation_{—}blocks[t]
        portion_{—}dmvr_{—}blocks[t]
        portion_{—}bdof_{—}blocks[t]
        portion_{—}prof_{—}blocks[t]
        portion_{—}ciip_{—}blocks_{—}area[t]
        portion_{—}gpm_{—}blocks_{—}area[t]
      }
      portion_deblocking_instances[t]
      portion_{—}alf_{—}instances[t]
      portion_{—}ccalf_{—}instances[t]
      portion_{—}lmcs_{—}instances[t]
    }
  }
  break;
  case 1:
    xsd_metric_type
    xsd_metric_value
    break;
  default:
}
```

An example of semantic of the syntax element green_metadata_type is as follows:
green_metadata_type: specifies the type of metadata that is present in the SEI message. If green_metadata_type is “0”, then complexity metrics are present. Otherwise, if green_metadata_type is “1”, then metadata enabling quality recovery after low-power encoding is present. Other values of green_metadata_type are reserved for future use by ISO/IEC.

In the following is provided an example of semantic of the various syntax elements discussed above:
period_type specifies the type of upcoming period over which the complexity metrics are applicable and is defined in the following table:

TABLE TAB7

| Value | Description |
|---|---|
| 0 | complexity metrics are applicable to a single picture |
| 1 | complexity metrics are applicable to all pictures in |
| | decoding order, up to (but not including) the picture |
| | containing the next I slice |
| 2 | complexity metrics are applicable over a specified time |
| | interval in seconds |
| 3 | complexity metrics are applicable over a specified number |
| | of pictures counted in decoding order |
| 4 | complexity metrics are applicable to a single picture with |
| | slice, tile granularity |
| 5 | complexity metrics are applicable to a single picture with |
| | subpicture granularity |
| 5-0xFF | reserved |

num_seconds indicates the number of seconds over which the complexity metrics are applicable when period_type is “2”.
num_pictures specifies the number of pictures, counted in decoding order, over which the complexity metrics are applicable when period_type is “3”.
NumPicsInPeriod is the number of pictures in the specified period. When period_type is “0”, then NumPicsInPeriod is “1”. When period_type is “1”, then NumPicsInPeriod is determined by counting the pictures in decoding order up to (but not including) the one containing the next I slice. When period_type is “2”, then NumPicsInPeriod is determined from the frame rate. When period_type is “3”, then NumPicsInPeriod is equal to num_pictures.
total_number_4×4_blocks_in_period specifies the total number of 4×4 blocks that are coded in the specified period. The parameter TotalNum4×4BlocksInPeriod is derived as follows. TotalNum4×4BlocksInPeriod is the total number of 4×4 blocks that are coded in the specified period. TotalNum4×4BlocksInPeriod is derived as follows:
   TotalNum4×4BlocksInPeriod is set equal to total_number_4×4blocks_in_period;
   When the following conditions are true, TotalNum4×4BlocksInPeriod is set equal to (num_seconds×TotalNum4×4BlocksInPeriod):
   period_type is equal to 2;
   num_seconds is greater than 1;
   When the following conditions are true, TotalNum4×4BlocksInPeriod is set equal to (num_pictures×TotalNum4×4BlocksInPeriod+64)/128:
   period_type is equal to 3;
   num_pictures is greater than 128
portion_non_zero_blocks_area indicates the portion of area covered by blocks with non-zero transform coefficients values, in the pictures of the specified period, using a 4×4 blocks granularity and is defined as follows:

$$portion\_non \_zero \_blocks \_area = Floor ( \frac{NumNonZeroBlocks}{TotalNum 4 \times 4 BlocksInPeriod} * 255 )$$

where NumNonZeroBlocks is the number of blocks with non-zero transform coefficients values in the specified period using 4×4 granularity. At the encoder side, NumNonZeroBlocks is computed as follows:

$$NumNonZeroBlocks = NumNonZero 16 Blocks + 2 * NumNonZero 32 Blocks + 4 * NumNonZero 64 Blocks + 8 * NumNonZero 128 Blocks + 16 * NumNonZero 256 Blocks + 32 * NumNonZero 512 Blocks + 64 * NumNonZero 1024 Blocks + 128 * NumNonZero 2048 Blocks + 256 * NumNonZero 4096 Blocks$$

where NumNonZeroXBlocks are the number of blocks with non-zero transform coefficients values, for number of samples from X=16, 32, 64, 128, 256, 512, 1024, 2048, 4096, respectively, in the specified period.
NumNonZeroBlocks is derived from portion_non_zero_blocks_area and TotalNum4×4BlocksInPeriod in the decoder.
portion_64_blocks_in_non_zero_area indicates the portion of “64” samples blocks area in the non-zero area in the specified period and is defined as follows:

$$portion\_ 64 \_blocks \_in \_non \_zero \_area = Floor ( \frac{4 * NumNonZero 64 Blocks}{NumNonZeroBlocks} * 255 )$$

When not present, is equal to “0”.
NumNonZero64Blocks is the number of “64” samples blocks with non-zero transform coefficients values in the specified period. It is derived from portion_64_blocks_in_non_zero_area and NumNonZeroBlocks in the decoder.
portion_128_blocks_in_non_zero_area indicates the portion of “128” samples blocks area in the non-zero area in the specified period and is defined as follows:

$$portion\_ 128 \_blocks \_in \_non \_zero \_area = Floor ( \frac{8 * NumNonZero 128 Blocks}{NumNonZeroBlocks} * 255 )$$

When not present, is equal to “0”.
NumNonZero128Blocks is the number of “128” samples blocks with non-zero transform coefficients values in the specified period. It is derived from portion_128_blocks_in_non_zero_area and NumNonZeroBlocks in the decoder.
portion_256_blocks_in_non_zero_area indicates the portion of “256” samples blocks area in the non-zero area in the specified period and is defined as follows:

$$portion\_ 256 \_blocks \_in \_non \_zero \_area = Floor ( \frac{16 * NumNonZero 256 Blocks}{NumNonZeroBlocks} * 255 )$$

When not present, is equal to “0”.
NumNonZero256Blocks is the number of 256 samples blocks with non-zero transform coefficients values in the specified period. It is derived from portion_256_blocks_in_non_zero_area and NumNonZeroBlocks in the decoder.
portion_512_blocks_in_non_zero_area indicates the portion of “512” samples blocks area in the non-zero area in the specified period and is defined as follows:

$$portion\_ 512 \_blocks \_in \_non \_zero \_area = Floor ( \frac{32 * NumNonZero 512 Blocks}{NumNonZeroBlocks} * 255 )$$

When not present, is equal to “0”.
NumNonZero512Blocks is the number of 512 samples blocks with non-zero transform coefficients values in the specified period. It is derived from portion_512_blocks_in_non_zero_area and NumNonZeroBlocks in the decoder.
portion_1024_blocks_in_non_zero_area indicates the portion of “1024” samples blocks area in the non-zero area in the specified period and is defined as follows:

$$portion\_ 1024 \_blocks \_in \_non \_zero \_area = Floor ( \frac{64 * NumNonZero 1024 Blocks}{NumNonZeroBlocks} * 255 )$$

When not present, is equal to “0”.
NumNonZero1024Blocks is the number of “1024” samples blocks with non-zero transform coefficients values in the specified period. It is derived from portion_1024_blocks_in_non_zero_area and NumNonZeroBlocks in the decoder.
portion_2048_blocks_in_non_zero_area indicates the portion of “2048” samples blocks area in the non-zero area in the specified period and is defined as follows:

$$portion\_ 2048 \_blocks \_in \_non \_zero \_area = Floor ( \frac{128 * NumNonZero 2048 Blocks}{NumNonZeroBlocks} * 255 )$$

When not present, is equal to “0”.
NumNonZero2048Blocks is the number of “2048” samples blocks with non-zero transform coefficients values in the specified period. It is derived from portion_2048_blocks_in_non_zero_area and NumNonZeroBlocks in the decoder.
portion_4096_blocks_in_non_zero_area indicates the portion of “4096” samples blocks area in the non-zero area in the specified period and is defined as follows:

$$portion\_ 4096 \_blocks \_in \_non \_zero \_area = Floor ( \frac{256 * NumNonZero 4096 Blocks}{NumNonZeroBlocks} * 255 )$$

When not present, is equal to “0”.
NumNonZero4096Blocks is the number of “4096” samples blocks with non-zero transform coefficients values in the specified period. It is derived from portion_4096_blocks_in_non_zero_area and NumNonZeroBlocks in the decoder.
NumNonZero16Blocks is the number of “16” samples blocks with non-zero transform coefficients values in the specified period. NumNonZero4×4Blocks is derived from NumNonZeroBlocks, NumNonZero64Blocks, NumNonZero128Blocks, NumNonZero256Blocks, NumNonZero512Blocks, NumNonZero1024Blocks, NumNonZero2048Blocks, and NumNonZero4096Blocks as follows in the decoder:

$$NumNonZero 16 Blocks = NumNonZeroBlocks - 4 * NumNonZero 64 Blocks - 8 * NumNonZero 128 Blocks - 16 * NumNonZero 256 Blocks - 32 * NumNonZero 512 Blocks - 64 * NumNonZero 1024 Blocks - 128 * NumNonZero 2048 Blocks - 256 * NumNonZero 4096 Blocks$$

portion_jccr_blocks_area indicates the portion of area covered by JCCR coded blocks in the pictures of the specified period using 4×4 granularity and is defined as follows:

$$portion\_jccr \_blocks \_area = Floor ( \frac{NumJccrCodedBlocks}{TotalNum 4 \times 4 BlocksInPeriod} * 255 )$$

NumJccrCodedBlocks is the number of blocks coded as JCCR in the specified period using 4×4 granularity. At the encoder side, it is computed as follows:

$$NumJccrCodedBlocks = NumJccrCoded\_ 16 Blocks + 2 * NumJccrCoded 32 Blocks + 4 * NumJccrCoded 64 Blocks + 16 * NumJccrCoded\_ 128 Blocks + 32 * NumJccrCoded\_ 256 Blocks + 65 * NumJccrCoded\_ 1024 Blocks + 128 * NumJccrCoded\_ 2048 Blocks + 256 * NumJccrCoded\_ 4096 Blocks$$

Where NurtaccrCoded_XBlocks are the number of blocks coded as JCCR for number of samples X=16, 32, 64, 128, 256, 512, 1024, 2048, 4096, in the specified period.
NurtaccrCodedBlocks is derived from portion_jccr_blocks_area and TotalNum4×4BlocksInPeriod in the decoder.
portion_trtype0_blocks_area indicates the portion of area covered by blocks using the transform of type “0” in the pictures of the specified period, using 4×4 granularity and is defined as follows:

$$portion\_trtype 0 \_blocks \_area = Floor ( \frac{NumTrType 0 Blocks}{TotalNum 4 \times 4 BlocksInPeriod} * 255 )$$

NumTrType0Blocks is the number of blocks using the transform of type “0” in the specified period using 4×4 granularity. At the encoder side, it is computed as follows:

$$NumTrType 0 Blocks = NumTrType0\_ 16 Blocks + 2 * NumTrType0\_ 32 Blocks + 4 * NumTrType0\_ 64 Blocks + 8 * NumTrType0\_ 128 Blocks + 16 * NumTrType0\_ 256 Blocks + 32 * NumTrType0\_ 512 Blocks + 64 * NumTrType0\_ 1024 Blocks + 128 * NumTrType0\_ 2048 Blocks + 256 * NumTrType0\_ 4096 Blocks$$

Where NumTrType0_XBlocks are the number of blocks using transform type “0”, for number of samples from X=16, 32, 64, 128, 256, 512, 1024, 2048, 4096, in the specified period.
NumTrType0Blocks is derived from portion_trtype0_blocks_area and TotalNum4×4BlocksInPeriod in the decoder.
portion_trtype1_2_blocks_area indicates the portion of area covered by blocks using the transform of type 1 or 2 in the pictures of the specified period using 4×4 granularity and is defined as follows:

$$portion\_trtype 1 \_ 2 \_blocks \_area = Floor ( \frac{NumTrType 1 \_ 2 Blocks}{TotalNum 4 \times 4 BlocksInPeriod} * 255 )$$

NumTrType1_2Blocks is the number of blocks using the transform of type “0” in the specified period using 4×4 granularity. At the encoder side, it is computed as follows:

$$NumTrType1\_ 2 Blocks = NumTrType1\_ 2 \_ 16 Blocks + 2 * NumTrType1\_ 2 \_ 32 Blocks + 4 * NumTrType1\_ 2 \_ 64 Blocks + 8 * NumTrType1\_ 2 \_ 128 Blocks + 16 * NumTrType1\_ 2 \_ 256 Blocks + 32 * NumTrType1\_ 2 \_ 512 Blocks + 64 * NumTrType1\_ 2 \_ 1024 Blocks$$

Where NumTrType1_2_XBlocks are the number of blocks using transform types 1 or 2, for number of samples from X=16, 32, 64, 128, 256, 512, 1024, in the specified period.
NumTrType1_2Blocks is derived from portion_trtype1_2_blocks_area and TotalNum4×4BlocksInPeriod in the decoder.
portion_lfnst_blocks_area indicates the portion of area covered by blocks using the LFNST transform in the pictures of the specified period, using 4×4 granularity and is defined as follows:

$$portion\_lfnst \_blocks \_area = Floor ( \frac{NumLfnstBlocks}{TotalNum 4 \times 4 BlocksInPeriod} * 255 )$$

NumLfnstBlocks is the area covered by blocks using the LFNST transform in the specified period using 4×4 granularity. At the encoder side, it is computed as follows:

NumLfnstBlocks=16*NumLfnst16×16Blocks+48*NumLfnst48×16Blocks
Where NumLfnst16×16Blocks and NumLfnst48×16Blocks are the number of blocks using the LFNST transform of size 16×16 and 48×16, respectively, in the specified period.
NumLfnstBlocks is derived from portion_lfnst_blocks_area and TotalNum4×4BlocksInPeriod in the decoder.
portion_intra_predicted_blocks_area indicates the portion of area covered by intra predicted blocks in the pictures of the specified period using 4×4 granularity and is defined as follows:

$$portion\_intra \_predicted \_blocks \_area = Floor ( \frac{NumIntraPredictedBlocks}{TotalNum 4 \times 4 BlocksInPerdiod} * 255 )$$

NumIntraPredictedBlocks is the number of intra predicted blocks in the specified period using 4×4 granularity. At the encoder side, it is computed as follows:

$$NumIntraPredictedBlocks = NumIntraPredicted 16 Blocks + 2 * NumIntraPredicted 32 Blocks + 4 * NumIntraPredicted 64 Blocks + 8 * NumIntraPredicted 128 Blocks + 16 * NumIntraPredicted 256 Blocks + 32 * NumIntraPredicted 512 Blocks + 64 * NumIntraPredicted 1024 Blocks + 128 * NumIntraPredicted 2048 Blocks + 256 * NumIntraPredicted 4096 Blocks$$

Where NumIntraPredictedBlocks are the number of blocks using intra prediction, for number of samples from X=16, 32, 64, 128, 256, 512, 1024, 2048, 4096, in the specified period.
NumIntraPredictedBlocks is derived from portion_intra_predicted_blocks_area and TotalNum4×4BlocksInPeriod in the decoder.
portion_uni_predicted_blocks_area indicates the portion of area covered by inter uni-predicted blocks in the pictures of the specified period using 4×4 granularity and is defined as follows:

$$portion\_uni \_predicted \_blocks \_area = Floor ( \frac{NumUniPredictedBlocks}{TotalNum 4 \times 4 BlocksInPeriod} * 255 )$$

NumUniPredictedBlocks is the number of inter uni-predicted blocks in the specified period using 4×4 granularity. At the encoder side, it is computed as follows:

$$NumUniPredictedBlocks = NumUniPredicted 16 Blocks + 2 * NumUniPredicted 32 Blocks + 4 * NumUniPredicted 64 Blocks + 8 * NumUniPredicted 128 Blocks + 16 * NumUniPredicted 256 Blocks + 32 * NumUniPredicted 512 Blocks + 64 * NumUniPredicted 1024 Blocks + 128 * NumUniPredicted 2048 Blocks + 256 * NumUniPredicted 4096 Blocks$$

Where NumUniPredictedXBlocks are the number of blocks using inter uni-predicted prediction, for number of samples from X=16, 32, 64, 128, 256, 512, 1024, 2048, 4096, in the specified period.
NumUniPredictedBlocks is derived from portion_uni_predicted_blocks_area and TotalNum4×4BlocksInPeriod in the decoder.
portion_bi_predicted_blocks_area indicates the portion of area covered by inter bi-predicted blocks in the pictures of the specified period using 4×4 granularity and is defined as follows:

$$portion\_bi \_predicted \_blocks \_area = Floor ( \frac{NumBiPredictedBlocks}{TotalNum 4 \times 4 BlocksInPeriod} * 255 )$$

NumBiPredictedBlocks is the number of inter bi-predicted blocks in the specified period using 4×4 granularity. At the encoder side, it is computed as follows:

$$NumBiPredictedBlocks = NumBiPredicted 16 Blocks + 2 * NumBiPredicted 32 Blocks + 4 * NumBiPredicted 64 Blocks + 8 * NumBiPredicted 128 Blocks + 16 * NumBiPredicted 256 Blocks + 32 * NumBiPredicted 512 Blocks + 64 * NumBiPredicted 1024 Blocks + 128 * NumBiPredicted 2048 Blocks + 256 * NumBiPredicted 4096 Blocks$$

Where NumBiPredictedXBlocks are the number of blocks using inter bi-predicted prediction, for number of samples from X=16, 32, 64, 128, 256, 512, 1024, 2048, 4096, in the specified period.
NumBiPredictedBlocks is derived from portion_bi_predicted_blocks_area and TotalNum4×4BlocksInPeriod in the decoder.
portion_planar_blocks_in_intra_area indicates the portion of planar blocks area in the intra predicted area in the specified period and is defined as follows:

$$portion\_planar \_blocks \_in \_intra \_area = Floor ( \frac{NumPlanarPredictedBlocks}{NumIntraPredictedBlocks} * 255 )$$

When not present, is equal to “0”.
NumPlanarPredictedBlocks is the number of intra planar predicted blocks in the specified period using 4×4 granularity. At the encoder side, it is computed as follows:

$$NumPlanarPredicted Blocks = NumPlanarPredicted 16 Blocks + 2 * NumPlanarPredicted 32 Blocks + 4 * NumPlanarPredicted 64 Blocks + 8 * NumPlanarPredicted 128 Blocks + 16 * NumPlanarPredicted 256 Blocks + 32 * NumPlanarPredicted 512 Blocks + 64 * NumPlanarPredicted 1024 Blocks + 128 * NumPlanarPredicted \text{} 2048 Blocks + 256 * NumPlanarPredicted 4096 Blocks$$

Where NumPlanarPredictedXBlocks are the number of blocks using intra planar prediction, for number of samples from X=16, 32, 64, 128, 256, 512, 1024, 2048, 4096, in the specified period.
NumPlanarPredictedBlocks is derived from portion_planar_blocks_in_intra_area and TotalNum4×4BlocksInPeriod in the decoder.
portion_dc_blocks_in_intra_area indicates the portion of DC blocks area in the intra predicted area in the specified period and is defined as follows:

$$portion\_dc \_blocks \_in \_intra \_area = Floor ( \frac{NumDcPredictedBlocks}{NumIntraPredictedBlocks} * 255 )$$

When not present, is equal to “0”.
NumDcPredictedBlocks is the number of intra dc predicted blocks in the specified period using 4×4 granularity. At the encoder side, it is computed as follows:

$$NumDcPredicted Blocks = NumDcPredicted 16 Blocks + 2 * NumDcPredicted 32 Blocks + 4 * NumDcPredicted 64 Blocks + 8 * NumDcPredicted 128 Blocks + 16 * NumDcPredicted 256 Blocks + 32 * NumDcPredicted 512 Blocks + 64 * NumDcPredicted 1024 Blocks ++ 128 * NumDcPredicted \text{} 2048 Blocks + 256 * NumDcPredicted 4096 Blocks$$

Where NumDcPredictedXBlocks are the number of blocks using intra DC prediction, for number of samples from X=16, 32, 64, 128, 256, 512, 1024, 2048, 4096, in the specified period.
NumDcPredictedBlocks is derived from portion_dc_blocks_in_intra_area and TotalNum4×4BlocksInPeriod in the decoder.
portion_angular_hv_blocks_in_intra_area indicates the portion of angular horizontal or vertical blocks area in the intra predicted area in the specified period and is defined as follows:

$$portion\_angular \_hv \_blocks \_in \_intra \_area = ( \frac{NumAngularHVPredictedBlocks}{NumIntraPredictedBlocks} * 255 )$$

When not present, is equal to “0”.
NumAngularHVPredictedBlocks is the number of intra angular horizontally or vertically predicted blocks in the specified period using 4×4 granularity. At the encoder side, it is computed as follows:

$$NumAngularHVPredicted Blocks = NumAngularHVPredicted 16 Blocks + 2 * NumAngularHVPredicted \text{} 32 Blocks + 4 * NumAngularHVPredicted 64 Blocks + 8 * NumAngularHVPredicted 128 Blocks + 16 * NumAngularHVPredicted 256 Blocks + 32 * NumAngularHVPredicted 512 Blocks + 64 * NumAngularHVPredicted 1024 Blocks + 128 * NumAngularHVPredicted \text{} 2048 Blocks + 256 * NumAngularHVPredicted 4096 Blocks$$

Where NumAngularHVPredictedXBlocks are the number of blocks using intra angular horizontal or vertical prediction, for number of samples from X=16, 32, 64, 128, 256, 512, 1024, 2048, 4096, in the specified period.
NumAngularHVPredictedBlocks is derived from portion_angular_hv_blocks_in_intra_area and NumIntraPredictedBlocks in the decoder.
portion_mip_blocks_in_intra_area indicates the portion of MIP predicted blocks area in the intra predicted area in the specified period and is defined as follows:

$$portion\_mip \_blocks \_in \_intra \_area = Floor ( \frac{NumMipPredictedBlocks}{NumIntraPredictedBlocks} * 255 )$$

When not present, is equal to “0”.
NumMipPredictedBlocks is the number of intra MIP predicted blocks in the specified period using 4×4 granularity. At the encoder side, it is computed as follows:

$$NumMipPredicted Blocks = NumMipPredicted 16 Blocks + 2 * NumMipPredicted 32 Blocks + 4 * NumMipPredicted 64 Blocks + 8 * NumMipPredicted 128 Blocks + 16 * NumMipPredicted 256 Blocks + 32 * NumMipPredicted 512 Blocks + 64 * NumMipPredicted 1024 Blocks + 128 * NumMipPredicted \text{} 2048 Blocks + 256 * NumMipPredicted 4096 Blocks$$

Where NumMipPredictedXBlocks are the number of blocks using intra MIP prediction, for number of samples from X=16, 32, 64, 128, 256, 512, 1024, 2048, 4096, in the specified period.
NumMipPredictedBlocks is derived from portion_mip_blocks_in_intra_area and TotalNum4×4BlocksInPeriod in the decoder.
portion_cclm_blocks_in_intra_area indicates the portion of blocks area using the CCLM mode in the intra predicted area in the specified period and is defined as follows:

$$portion\_cclm \_blocks \_in \_intra \_area = Floor ( \frac{NumCclmPredictedBlocks}{NumIntraPredictedBlocks} * 255 )$$

When not present, is equal to “0”.
NumCclmPredictedBlocks is the number of intra CCLM chroma predicted blocks in the specified period using 4×4 granularity. At the encoder side, it is computed as follows:

$$NumCclmPredicted Blocks = NumCclmPredicted 16 Blocks + 2 * NumCclmPredicted 32 Blocks + 4 * NumCclmPredicted 64 Blocks + 8 * NumCclmPredicted 128 Blocks + 16 * NumCclmPredicted 256 Blocks + 32 * NumCclmPredicted 512 Blocks + 64 * NumCclmPredicted 1024 Blocks + 128 * NumCclmPredicted \text{} 2048 \text{} Blocks + 256 * NumCclmPredicted 4096 Blocks$$

Where NumCclmPredictedXBlocks are the number of blocks using intra CCLM prediction, for number of samples from X=16, 32, 64, 128, 256, 512, 1024, 2048 in the specified period.
NumCclmPredictedBlocks is derived from portion_cclm_blocks_in_intra_area and TotalNum4×4BlocksInPeriod in the decoder.
portion_ibc_blocks_in_intra_area indicates the portion of blocks area using the IBC mode in the intra predicted area in the specified period and is defined as follows:

$$portion\_ibc \_blocks \_in \_intra \_area = Floor ( \frac{NumIbcPredictedBlocks}{NumIntraPredictedBlocks} * 255 )$$

When not present, is equal to “0”.
NumIbcPredictedBlocks is the number of intra IBC predicted blocks in the specified period using 4×4 granularity. At the encoder side, it is computed as follows:

$$NumIbcPredicted Blocks = NumIbcPredicted 16 Blocks + 2 * NumIbcPredicted 32 Blocks + 4 * NumIbcPredicted 64 Blocks + 8 * NumIbcPredicted 128 Blocks + 16 * NumIbcPredicted 256 Blocks + 32 * NumIbcPredicted 512 Blocks + 64 * NumIbcPredicted 1024 Blocks + 128 * NumIbcPredicted \text{} 2048 \text{} Blocks + 256 * NumIbcPredicted 4096 Blocks$$

Where NumIbcPredictedXBlocks are the number of blocks using intra IBC prediction, for number of samples from X=16, 32, 64, 128, 256, 512, 1024, 2048, 4096 in the specified period.
NumIbcPredictedBlocks is derived from portion_ibc_blocks_in_intra_area and TotalNum4×4BlocksInPeriod in the decoder.
portion_integer_interpolation_blocks indicates the portion of prediction blocks whose luma samples positions are located in horizontal and vertical integer-sample position, in the specified period and is defined as follows:

$$portion\_integer \_interpolation \_blocks = ( \frac{NumBlocksIntegerInterpolation}{TotalNum 4 x 4 BlocksInPeriod} * 255 )$$

When not present, is equal to “0”.
NumBlocksIntegerInterpolation is the number of prediction blocks whose luma samples positions are located in horizontal and vertical integer-sample position, in the specified period. It is derived from portion_integer_interpolation_blocks and TotalNum4×4BlocksInPeriod in the decoder.
portion_hor_or_ver_interpolation_blocks indicates the portion of prediction blocks whose luma samples positions are located in integer-sample position in one of the horizontal or vertical directions, and in sub-sample position in the other direction, in the specified period and is defined as follows:

$$portion\_hor \_or \_ver \_interpolation \_blocks = ( \frac{NumBlocksHorOrVerInterpolation}{TotalNum 4 x 4 BlocksInPeriod} * 255 )$$

When not present, is equal to “0”.
NumBlocksHorOrVerInterpolation is the number of prediction blocks whose luma samples positions are located in integer-sample position in one of the horizontal or vertical directions, in the specified period. It is derived from portion_hor_or_ver_interpolation_blocks and TotalNum4×4BlocksInPeriod in the decoder.
portion_hor_and_ver_interpolation_blocks indicates the portion of prediction blocks whose luma samples positions are located in sub-sample position in both horizontal and vertical directions, in the specified period and is defined as follows:

$$portion\_hor \_and \_ver \_interpolation \_blocks = Floor ( \frac{NumBlocksHorAndVerInterpolation}{TotalNum 4 x 4 BlocksInPeriod} * 255 )$$

When not present, is equal to “0”.
NumBlocksHorAndVerInterpolation is the number of prediction blocks whose luma samples positions are located in sub-sample position in both horizontal and vertical directions, in the specified period. It is derived from portion_hor_and_ver_interpolation_blocks and TotalNum4×4BlocksInPeriod in the decoder.
portion_dmvr_blocks indicates the portion of area covered by blocks applying DMVR in the pictures of the specified period using 4×4 granularity and is defined as follows:

$$portion\_dmvr \_blocks \_area = Floor ( \frac{NumDmvrBlocks}{TotalNum 4 x 4 BlocksInPeriod} * 255 )$$

NumBiPredictedBlocks is the number of inter bi-predicted blocks in the specified period using 4×4 granularity. At the encoder side, it is computed as follows:

$$NumBiPredictedBlocks = NumBiPredicted 16 Blocks + 2 * NumBiPredicted 32 Blocks + 4 * NumBiPredicted 64 Blocks + 8 * NumBiPredicted 128 Blocks + 16 * NumBiPredicted 256 Blocks + 32 * NumBiPredicted 512 Blocks + 64 * NumBiPredicted 1024 Blocks + 128 * NumBiPredicted 2048 Blocks + 256 * NumBiPredicted 4096 Blocks$$

Where NumBiPredictedXBlocks are the number of blocks using inter bi-predicted prediction, for number of samples from X=16, 32, 64, 128, 256, 512, 1024, 2048, 4096, in the specified period.
NumBiPredictedBlocks is derived from portion_bi_predicted_blocks_area and TotalNum4×4BlocksInPeriod in the decoder.
portion_bdof_blocks indicates the portion of blocks area using the BDOF filtering in the inter predicted area in the specified period and is defined as follows:

$$portion\_bdof \_blocks \_in \_intra \_area = Floor ( \frac{NumBdofPredictedBlocks}{NumIntraPredictedBlocks} * 255 )$$

When not present, is equal to “0”.
NumBdofPredictedBlocks is the number of inter predicted blocks using BDOF filtering in the specified period using 4×4 granularity. At the encoder side, it is computed as follows:

$$NumBdofPredictedBlocks = 4 * NumBdofPredicted 64 Blocks + 8 * NumBdofPredicted 128 Blocks + 16 * NumBdofPredicted 256 Blocks + 32 * NumBdofPredicted 512 Blocks + 64 * NumBdofPredicted 1024 Blocks + 128 * NumBdofPredicted 2048 Blocks + 256 * NumBdofPredicted 4096 Blocks$$

Where NumBdofPredictedXBlocks are the number of inter coded blocks using BDOF filtering, for number of samples from X=64, 128, 256, 512, 1024, 2048, 4096 in the specified period.
NumBdofPredictedBlocks is derived from portion_bdof_blocks_in_intra_area and TotalNum4×4BlocksInPeriod in the decoder.
portion_prof_blocks indicates the portion of blocks area using the PROF filtering in the inter predicted area in the specified period and is defined as follows:

$$portion\_prof \_blocks \_in \_intra \_area = Floor ( \frac{NumProfPredictedBlocks}{NumIntraPredictedBlocks} * 255 )$$

When not present, is equal to “0”.
NumProfPredictedBlocks is the number of inter predicted blocks using PROF filtering in the specified period using 4×4 granularity. At the encoder side, it is computed as follows:

$$NumProfPredictedBlocks = NumProfPredicted 16 Blocks + 2 * NumProfPredicted 32 Blocks + 4 * NumProfPredicted 64 Blocks + 8 * NumProfPredicted 128 Blocks + 16 * NumProfPredicted 256 Blocks + 32 * NumProfPredicted 512 Blocks + 64 * NumProfPredicted 1024 Blocks + 128 * NumProfPredicted 2048 Blocks + 256 * NumProfPredicted 4096 Blocks$$

Where NumProfPredictedXBlocks are the number of inter coded blocks using PROF filtering, for number of samples from X=16, 32, 64, 128, 256, 512, 1024, 2048, 4096 in the specified period.
NumProfPredictedBlocks is derived from portion_prof_blocks_in_intra_area and TotalNum4×4BlocksInPeriod in the decoder.
portion_gpm_blocks_area indicates the portion of blocks area using the GPM inter predicted area in the specified period and is defined as follows:

$$portion\_gpm \_blocks \_in \_intra \_area = Floor ( \frac{NumGpmfPredictedBlocks}{NumIntraPredictedBlocks} * 255 )$$

When not present, is equal to “0”.
NumGpmPredictedBlocks is the number of inter predicted blocks using GPM in the specified period using 4×4 granularity. At the encoder side, it is computed as follows:

$$NumGpmPredictedBlocks = 4 * NumGpmPredicted 64 Blocks + 8 * NumGpmPredicted 128 Blocks + 16 * NumGpmPredicted 256 Blocks + 32 * NumGpmPredicted 512 Blocks + 64 * NumGpmPredicted 1024 Blocks + 128 * NumGpmPredicted 2048 Blocks + 256 * NumGpmPredicted 4096 Blocks$$

Where NumGpmPredictedXBlocks are the number of inter coded blocks using GPM, for number of samples from X=64, 128, 256, 512, 1024, 2048, 4096 in the specified period.
NumGpmPredictedBlocks is derived from portion_gpm_blocks_in_intra_area and TotalNum4×4BlocksInPeriod in the decoder.
portion deblocking instances indicates the portion of deblocking filtering instances, as defined in the Terms and definitions of this document, in the specified period and is defined as follows:

$$portion\_deblocking \_instances = ( \frac{NumDeblockingInstances}{4 * ChromaFormatMultiplier * TotalNum 4 x 4 BlocksInPeriod} * 255 )$$

ChromaFormatMultiplier depends on the VVC variables sps_chroma_format_idc as shown in the following table TAB8.

TABLE TAB8

| ChromaFormatMultiplier | chroma_format_idc | Comment |
|---|---|---|
| 1 | 0 | monochrome |
| 1.5 | 1 | 4:2:0 |
| | | sampling |
| 2 | 2 | 4:2:2 |
| | | sampling |
| 3 | 3 | 4:4:4 |
| | | sampling |

NumDeblockingInstances is the number of deblocking filtering instances in the specified period. It is derived from portion deblocking instances, TotalNum4×4BlocksInPeriod and ChromaFormatMultiplier in the decoder.
portion_alf_instances indicates the portion of ALF filtering instances, as defined in the Terms and definitions of this document, in the specified period and is defined as follows:

$$portion\_alf \_instances = Floor ( \frac{NumAlfInstances}{TotalNum 4 x 4 BlocksInPeriod} * 255 )$$

NumAlfInstances is the number of ALF filtering instances in the specified period. It is derived from portion_alf_instances, TotalNum4×4BlocksInPeriod in the decoder.
portion_ccalf_instances indicates the portion of CCALF filtering instances, as defined in the Terms and definitions of this document, in the specified period and is defined as follows:

$$portion\_ccalf \_instances = Floor ( \frac{NumCcalfgInstances}{TotalNum 4 x 4 BlocksInPeriod} * 255 )$$

NumCcalfInstances is the number of CCALF filtering instances in the specified period. It is derived from portion_ccalf_instances, TotalNum4×4BlocksInPeriod in the decoder.
max_num_slices_tiles_subpicture_minus1 specifies the maximum number between the number of slices and the number of tiles in the associated picture.
first_ctb_in_slice_or_tile_or_subpict[t] specifies the first Coding Tree Block (CTB) number in slice[t] or tile[t] in raster scan order.

In the case where period_type is equal to “4” (corresponding to signaling per slice or tile), the parameter TotalNum4×4BlocksInSliceOrTileOrSubpic[t] is defined as follows:

TotalNum4×4BlocksInSliceOrTileOrSubpic[t] is the total number of 4×4 blocks in the slice[t] or tile[t] and is determined by the following computation, using the parameters ctbToTileColIdx, ctbToTileRowIdx, ColWidthVal and RowHeightVal specified in the clause “CTB raster scanning, tile scanning, and subpicture scanning processes” in ISO/IEC 23090-3:

ctbAddrX=first_ctb_in_slice_or_tile_or_subpict[t]

tileColIdx=ctbToTileColIdx[ctbAddrX]

tileRowIdx=ctbToTileRowIdx[ctbAddrX]

tileWidth=ColWidthVal[tileColIdx]

tileHeight=RowHeightVal[tileRowIdx]

TotalNum4×4BlocksInSliceOrTileOrSubpic[t]=tileWidth*tileHeight*(1<<(Ctb Log 2SizeY−2))²

In the case where period_type is equal to “5” (corresponding to signaling per subpicture), the parameter TotalNum4×4BlocksInSliceOrTileOrSubpic[t] is defined as follows.

TotalNum4×4BlocksInSliceOrTileOrSubpic[t] is the total number of 4×4 blocks in the subpict[t] and is determined by the following computation, using the syntax elements sps_subpic_ctu_top_left_x and sps_subpic_ctu_top_left_y specified in the clause “Sequence parameter set RBSP semantics” in ISO/IEC 23090-3:

subpicWidth=1+sps_subpic_width_minus1[t]

subpicHeight=1+sps_subpic_height_minus1[t]

TotalNum4×4BlocksInSliceOrTileOrSubpic[t]=subpicWidth*subpicHeight*(1<<(Ctb Log 2SizeY−2))²

Then all the syntax elements described above are duplicated, with adding index [t] and replacing TotalNum4×4BlocksInPeriod by TotalNum4×4BlocksInSliceOrTileOrSubpic[t].

For instance, the following syntax element is added:
portion_non_zero_blocks_area[t] indicates the portion of area covered by blocks with non-zero transform coefficients values, in the slice[t] or tile[t] or subpicture[t], using a 4×4 blocks granularity and is defined as follows:

$$portion\_non \_zero \_blocks \_area [ t ] = ( \frac{NumNonZeroBlock s [ t ]}{TotalNum 4 x 4 BlocksInSliceOrTileOrSubpic [ t ]} * 255 )$$

where NumNonZeroBlocks[t] is the number of blocks with non-zero transform coefficients values in the slice[t] or tile[t] using 4×4 granularity. At the encoder side, NumNonZeroBlocks[t] is computed as follows:

$$NumNonZeroBl ocks [ t ] = NumNonZero 16 Blocks [ t ] + 2 * NumNonZero 32 Blocks [ t ] + 4 * NumNonZero 64 Blocks [ t ] + 8 * NumNonZero 128 Blocks [ t ] + 16 * NumNonZero 256 Blocks [ t ] + 32 * NumNonZero 512 Blocks [ t ] + 64 * NumNonZero 1024 Blocks [ t ] + 128 * NumNonZero 2048 Blocks [ t ] + 256 * NumNonZero 4096 Blocks [ t ]$$

where NumNonZeroXBlocks[t] are the number of blocks with non-zero transform coefficients values, for number of samples from X=16, 32, 64, 128, 256, 512, 1024, 2048, 4096, respectively, in the slice[t] or tilde
NumNonZeroBlocks[t] is derived from portion_non_zero_blocks_area[t] and TotalNum4×4BlocksInSliceOrTileOrSubpic[t] in the decoder.

More explicitly, at the decoder, the parameters TotalNum4×4BlocksInSliceOrTileOrSubpicture[t] and portion_non_zero_blocks_area[t] are used to derive the number of 4×4 (or 16 samples) blocks, NumNonZeroBlocks[t], that contain non-zero transform coefficients. This number is derived as:

$$NumNonZeroBlocks [ t ] = TotalNum 4 x 4 BlocksInSliceOrTileOrSubpicture [ t ] * portion\_non \_zero \_blocks \_area [ t ]$$

And so on for all the other syntax elements related to usage ratios of coding modes, such as the syntax elements portion_64_blocks_in_non_zero_area[t] or portion_alf_instances[t] signaled in table Tab6, that are computed at the encoder from parameters NumNonZero64Blocks[t] or NumAlfInstances[t] then signaled in the SEI, and that are decoded from the SEI at the decoder and used to derive the parameters NumNonZero64Blocks[t] or NumAlfInstances[t], respectively. The parameters such as NumNonZeroBlocks[t], NumNonZero64Blocks[t] or NumAlfInstances[t], are exploited by the decoder to vary operating frequency and thus reduce decoder power consumption, as described for instance in the Annex B.1 of ISO/IEC 23001-11 (green metadata) specification.

In an embodiment, syntax elements related to decoding complexity metrics are grouped or removed to get a more compact representation of the metadata. An example is provided in table TAB9. In table TAB9, the granularity for indicating the metrics is not 4×4 blocks, but blocks of “4” samples, which correspond to a smallest transform block supported in some implementations. For example syntax elements related to non-zero areas are grouped for different block sizes, leading to “4” syntax elements portion_non_zero_4_8_16_blocks_area (comprising transform blocks of size “4”, “8”, and “16” samples), portion_non_zero_32_64_128_blocks_area (comprising transform blocks of size “32”, “64”, and “128” samples), portion_non_zero_256_512_1024_blocks_area (comprising transform blocks of size “256”, “512” and “1024” samples) and portion_non_zero_2048_4096_blocks_area (comprising transform blocks of size “2048” and “4096” samples). Several syntax elements related to transform have been removed (portion_jccr_blocks_area, portion_trtype0_blocks_area, portion_trtype1_2_blocks_area, portion_lfnst_blocks_area, portion_bdpcm_blocks_area). Intra- and inter-related syntax elements have also been simplified. portion non zero transform coefficients area indicates the portion of non-zero coefficients in non-zero blocks.

For intra part, only “4” syntax elements are considered: portion_planar_blocks_in_intra_area (portion of blocks prediction using planar prediction), portion_dc_blocks_in_intra_area (portion of blocks prediction using DC prediction), portion_angular_hv_blocks_in_intra_area (portion of blocks prediction using direction horizontal or vertical prediction), portion_mip_blocks_in_intra_area (portion of blocks prediction using MIP prediction).

For inter part, only portion_bi_and_gpm_predicted_blocks_area is defined, and uni-prediction portion can be deduced from it and from the total number of blocks in a period.

For loop-filtering, syntax elements for each loop-filter is defined: portion_deblocking_instances, portion_sao_filtered_blocks, portion_alf_filtered_blocks.

TABLE TAB9

| | Size | Descriptor |
|---|---|---|
| period_type | 8 | unsigned integer |
| if ( period_type = = 2 ) { | | |
| num_seconds | 16 | unsigned integer |
| } | | |
| else if ( period_type = = 3 ) { | | |
| num_pictures | 16 | unsigned integer |
| } | | |
| if ( period_type <= 3 ) { | | |
| portion_non_zero_blocks_area | 8 | unsigned integer |
| if ( portion_non_zero_blocks_area != 0 ) { | | |
| portion_non_zero_4_8_16_blocks_area | 8 | unsigned integer |
| portion_non_zero_32_64_128_blocks_area | 8 | unsigned integer |
| portion_non_zero_256_512_1024_blocks_area | 8 | unsigned integer |
| portion_non_zero_2048_4096_blocks_area | 8 | unsigned integer |
| } | | |
| portion_non_zero_transform_coefficients_area | 8 | unsigned integer |
| portion_intra_predicted_blocks_area | 8 | unsigned integer |
| if ( portion_intra_predicted_blocks_area = = 255 ) { | | |
| portion_planar_blocks_in_intra_area | 8 | unsigned integer |
| portion_dc_blocks_in_intra_area | 8 | unsigned integer |
| portion_angular_hv_blocks_in_intra_area | 8 | unsigned integer |
| portion_mip_blocks_in_intra_area | 8 | unsigned integer |
| } | | |
| else { | | |
| portion_bi_and_gpm_predicted_blocks_area | 8 | unsigned integer |
| } | | |
| portion_deblocking_instances | 8 | unsigned integer |
| portion_sao_filtered_blocks | 8 | unsigned integer |
| portion_alf_filtered_blocks | 8 | unsigned integer |
| } | | |
| else if ( period_type >= 4 \|\| period_type <= 8 ) { | | |
| max_num_segments_minus1 | 16 | unsigned integer |
| for ( t=0; t <= max_num_segments_minus1; t++ ) { | | |
| first_ctb_in_segment[ t ] | 16 | unsigned integer |
| portion_non_zero_blocks_area[ t ] | 8 | unsigned integer |
| if ( portion_non_zero_blocks_area[ t ] != 0 ) { | | |
| portion_non_zero_4_8_16_blocks_area[ t ] | 8 | unsigned integer |
| portion_non_zero_32_64_128_block_area[ t ] | 8 | unsigned integer |
| portion_non_zero_256_512_1024_blocks_area[ t ] | 8 | unsigned integer |
| portion_non_zero_2048_4096_blocks_area[ t ] | 8 | unsigned integer |
| } | | |
| portion_non_zero_transform_coefficients_area[ t ] | 8 | unsigned integer |
| portion_intra_predicted_blocks_area[ t ] | 8 | unsigned integer |
| if ( portion_intra_predicted_blocks_area[ t ] = = 255 ) { | | |
| portion_planar_blocks_in_intra_area[ t ] | 8 | unsigned integer |
| portion_dc_blocks_in_intra_area[ t ] | 8 | unsigned integer |
| portion_angular_hv_blocks_in_intra_area[ t ] | 8 | unsigned integer |
| portion_mip_blocks_in_intra_area[ t ] | 8 | unsigned integer |
| else { | | |
| portion_bi_and_gpm_predicted_blocks_area[ t ] | 8 | unsigned integer |
| portion_deblocking_instances[ t ] | 8 | unsigned integer |
| portion_sao_filtered_blocks[ t ] | 8 | unsigned integer |
| portion_alf_filtered_blocks[ t ] | 8 | unsigned integer |
| } | | |
| } | | |

period_type is defined as follows in table TAB10.

TABLE TAB10

| Value | Description |
|---|---|
| 0x00 | complexity metrics are applicable to a single picture |
| 0x01 | complexity metrics are applicable to all pictures in |
| | decoding order, up to (but not including) the picture |
| | containing the next I slice |
| 0x02 | complexity metrics are applicable to all pictures over a |
| | specified time interval in seconds |
| 0x03 | complexity metrics are applicable over a specified number |
| | of pictures counted in decoding order |
| 0x04 | complexity metrics are applicable to a single picture with |
| | slice or tile granularity |
| 0x05 | complexity metrics are applicable to a single picture with |
| | subpicture granularity |
| 0x06 | complexity metrics are applicable to all pictures in decoding |
| | order, up to (but not including) the picture containing the |
| | next I slice, with subpicture granularity |
| 0x07 | complexity metrics are applicable over a specified time |
| | interval in seconds, with subpicture granularity |
| 0x08 | complexity metrics are applicable over a specified number |
| | of pictures counted in decoding order, with subpicture |
| | granularity |
| 0x09-0xFF | reserved |

In the example of table TAB9 the maximum payload size for period_type lower than or equal to “3” is “14” bytes.

In this example the maximum payload size for period_type greater than “3” is (3+11*number of segments) bytes, where a segment is either defined as a tile, a slice or a subpicture in the picture.

In another embodiment improving the compacity of the decoding complexity metrics metadata, called first embodiment improving the compacity, the detailed syntax elements related non-zero blocks portion_non_zero_4_8_16_blocks_area, portion non_zero_32_64_128_blocks_area, portion_non_zero_256_512_1024_blocks_area, portion_non_zero_2048_4096_blocks_area, are further grouped. For instance, they are grouped into “2” syntax elements portion_non_zero_small_blocks_area and portion_non_zero_large_blocks_area, where small blocks are transform blocks with number of samples less than or equal to M samples, and large blocks are transform blocks with more than M samples. In an embodiment M is equal to “512” (which corresponds to transforms smaller than 32×32). In another embodiment M is equal to “1024” (which corresponds to transforms up to 32×32). In a variant of the first embodiment improving the compacity, the detailed syntax elements related non-zero blocks are removed and only portion_non_zero_blocks_area and portion_non_zero_transform_coefficients_area are kept as syntax elements qualifying the transform complexity.

In another embodiment improving the compacity of the decoding complexity metrics metadata, called second embodiment improving the compacity, the syntax elements related to intra coding are grouped, with one syntax element indicating the portion area using intra prediction, portion_intra_predicted_blocks_area, plus one syntax element indicating the usage of an MIP prediction, portion_mip_blocks_in_intra_area, among the area using intra prediction.

In a variant of the second embodiment improving the compacity, the syntax element portion_mip_blocks_in_intra_area is removed, and the syntax elements portion_planar_blocks_in_intra_area, portion_dc_blocks_in_intra_area, and portion_angular_hv_blocks_in_intra_area are kept, in addition to the syntax element portion_intrajredicted_blocks_area.

In another variant of the second embodiment improving the compacity, the syntax elements related to intra coding are removed, except the global counting syntax element portion_intra_predicted_blocks_area.

In another embodiment improving the compacity of the decoding complexity metrics metadata, called third embodiment improving the compacity, syntax elements related to loop filtering are grouped. For instance, portion_sao_filtered_blocks and portion_alf_filtered_blocks are grouped into portion_sao_alf_filtered_blocks.

Table TAB11 shows the most compact version of the decoding complexity metadata based on the first, second and third embodiments improving the compacity above aiming at reducing the payload size. Based on this version, the maximum payload size for period_type lower than or equal to “3” is “9” bytes (which means “5” bytes are saved compared to the extended version). The syntax elements are duplicated for each tile/slice/subpicture for period_type greater than “3”.

TABLE TAB11

| | Size (bits) | Descriptor |
|---|---|---|
| period_type | 8 | unsigned integer |
| if ( period_type = = 2 ) { | | |
| num_seconds | 16 | unsigned integer |
| } | | |
| else if ( period_type = = 3 ) { | | |
| num_pictures | 16 | unsigned integer |
| } | | |
| if ( period_type <= 3 ) { | | |
| portion_non_zero_blocks_area | 8 | unsigned integer |
| portion_non_zero_transform_coefficients_area | 8 | unsigned integer |
| portion_intra_predicted_blocks_area | 8 | unsigned integer |
| if ( portion_intra_predicted_blocks_area < 255 ) { | | |
| portion_bi_and_gpm_predicted_blocks_area | 8 | unsigned integer |
| } | | |
| portion_deblocking_instances | 8 | unsigned integer |
| portion_sao_alf filtered blocks | 8 | unsigned integer |
| } | | |
| ... | | |

In an embodiment, a syntax element is added to indicate if a compact version, or a complete version of the metadata payload, is used. For instance, this is indicated using a syntax element extended_representation_flag.

In order to keep a byte-aligned payload, when a flag is added, the bitlength for coding period_type is possibly reduced by “1” bit. This bitlength reduction can alternatively apply to any of the other syntax elements included in the payload. Alternatively, this is indicated by particular values of period_type. Alternatively, “8” bits are used for coding extended_representation_flag and “8” bits are used for coding period_type.

Table TAB12 below shows a resulting payload, enabling the compact and more detailed (extended) representation of the decoding complexity metrics. The example is only presented for period_type<=3 but can be easily generalized for the case of period_type>3 (tile/slice/subpicture version).

There are core syntax elements defined both for the compact and extended versions, i.e.:
portion_non_zero_blocks_area,
portion_non_zero_transform_coefficients_area,
portion_intra_predicted_blocks_area,
portion_bi_and_gpm_predicted_blocks_area,
portion_deblocking_instances, portion_sao_alf_filtered_blocks.

In addition, extended syntax elements are signaled when the extended version is used:
portion_non_zero_4_8_16_blocks_area,
portion non_zero_32_64_128_blocks_area,
portion_non_zero_256_512_1024_blocks_area,
portion_non_zero_2048_4096_blocks_area,
portion_planar_blocks_in_intra_area,
portion_dc_blocks_in_intra_area,
portion_angular_hv_blocks_in_intra_area,
portion_mip_blocks_in_intra_area.

TABLE TAB12

| | Size (bits) | Descriptor |
|---|---|---|
| extended_representation_flag | 1 | unsigned integer |
| period_type | 7 | unsigned integer |
| if ( period_type = = 2 ) { | | |
| num_seconds | 16 | unsigned integer |
| } | | |
| else if ( period_type = = 3 ) { | | |
| num_pictures | 16 | unsigned integer |
| } | | |
| if ( period_type <= 3 ) { | | |
| portion_non_zero_blocks_area | 8 | unsigned integer |
| portion_non_zero_transform_coefficients_area | 8 | unsigned integer |
| portion_intra_predicted_blocks_area | 8 | unsigned integer |
| if ( portion_intra_predicted_blocks_area < 255 ) { | | |
| portion_bi_and_gpm_predicted_blocks_area | 8 | unsigned integer |
| } | | |
| portion_deblocking_instances | 8 | unsigned integer |
| portion_sao_alf_filtered_blocks | 8 | unsigned integer |
| if (extended_representation_flag = = 0 ) { | | |
| if ( portion_non_zero_blocks_area != 0 ) { | | |
| portion_non_zero_4_8_16_blocks_area | 8 | unsigned integer |
| portion_non_zero_32_64_128_blocks_area | 8 | unsigned integer |
| portion_non_zero_256_512_1024_blocks_area | 8 | unsigned integer |
| portion_non_zero_2048_4096_blocks_area | 8 | unsigned integer |
| } | | |
| if ( portion_intra_predicted_blocks_area = = 255 ) { | | |
| portion_planar_blocks_in_intra_area | 8 | unsigned integer |
| portion_dc_blocks_in_intra_area | 8 | unsigned integer |
| portion_angular_hv_blocks_in_intra_area | 8 | unsigned integer |
| portion_mip_blocks_in_intra_area | 8 | unsigned integer |
| } | | |
| } | | |
| } | | |
| ... | | |

In an embodiment, the flag extended_representation_flag is only signalled for the tile/slice/subpicture case, that is, when period_type is greater than “3” when referring to the period_type definition used in this document.

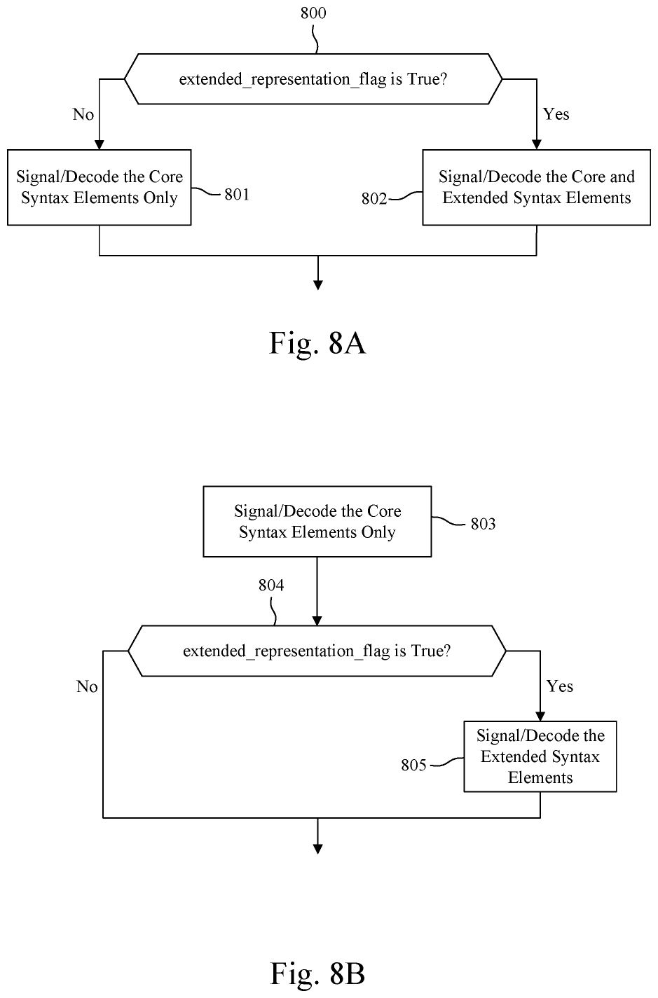

An example of signalling/decoding process is illustrated in FIGS. 8A and 8B with two different implementations.

In FIG. 8A, the value of extended_representation_flag is checked in a step 800. If extended_representation_flag is false, then only the core syntax elements are decoded in a step 801. If extended_representation_flag is true, then the core and extended syntax elements are decoded in a step 802.

In FIG. 8B, the core syntax elements only are decoded in a step 803. Then the value of extended_representation_flag is checked in a step 804. If extended_representation_flag is true, then the extended syntax elements are decoded in step 805.

In another embodiment, there is no distinction in period_type value between tile/slice case and subpicture case. Instead, period_type value can indicate whether tile/slice/subpicture granularity is used or not, as indicated in bold font in the table TAB13 below.

TABLE TAB13

| Value | Description |
|---|---|
| 0x00 | complexity metrics are applicable to a single picture |
| 0x01 | complexity metrics are applicable to all pictures in decoding |
| | order, up to (but not including) the picture containing the next |
| | I slice |
| 0x02 | complexity metrics are applicable to all pictures over a |
| | specified time interval in seconds |
| 0x03 | complexity metrics are applicable over a specified number of |
| | pictures counted in decoding order |
| 0x04 | complexity metrics are applicable to a single picture with |
| | slice or tile or subpicture granularity |
| 0x05 | complexity metrics are applicable to all pictures in decoding |
| | order, up to (but not including) the picture containing the next |
| | I slice with slice or tile or subpicture granularity |
| 0x06 | complexity metrics are applicable to all pictures over a specified |
| | time interval in seconds with slice or tile or subpicture granularity |
| 0x07 | complexity metrics are applicable over a specified number of |
| | pictures counted in decoding order with slice or tile or subpicture |
| | granularity |
| . . . | |

When tile/slice/subpicture granularity is used, an additional syntax element is added to indicate which type of segment is used, among the tile, slice or subpicture. In the table below, this syntax element is named type_segments. When type_segments=0, the segments correspond to tiles, when type_segments=1, the segments correspond to slices, when type_segments=2, the segments correspond to subpictures. Alternatively, when type_segments=0, the segments correspond to tiles or slices, when type_segments=1, the segments correspond to subpictures. Other values are reserved for other types of segments that may be defined in the future or for specific applications.

The table TAB14 below comprises this new syntax element type_segments for the case of tile/slice/subpicture granularity, corresponding to period_type>=4.

TABLE TAB14

| | | |
|---|---|---|
| ... | | |
| else if ( period_type >= 4 ) { | | |
| type_segments | 8 | unsigned integer |
| max_num_segments_minus1 | 16 | unsigned integer |
| for ( t=0; t<=max_num_segments_minus1; t++ ) { | | |
| first_ctb_in segment[ t ] | 16 | unsigned integer |
| portion_non_zero_blocks_area[ t ] | 8 | unsigned integer |
| if ( portion_non_zero_blocks_area[ t ] != 0 ) { | | |
| portion_non_zero_4_8_16_blocks_area[ t ] | 8 | unsigned integer |
| portion_non_zero_32_64_128_block_area[ t ] | 8 | unsigned integer |
| portion_non_zero_256_512_1024_blocks_area[ t ] | 8 | unsigned integer |
| portion_non_zero_2048_4096_blocks_area[ t ] | 8 | unsigned integer |
| } | | |
| portion_non_zero_transform_coefficients_area[ t ] | 8 | unsigned integer |
| portion_intra_predicted_blocks_area[ t ] | 8 | unsigned integer |
| if ( portion_intra_predicted_blocks_area[ t ] = = 255 ) { | | |
| portion_planar_blocks_in_intra_area[ t ] | 8 | unsigned integer |
| portion_dc_blocks_in_intra_area[ t ] | 8 | unsigned integer |
| portion_angular_hv_blocks_in_intra_area[ t ] | 8 | unsigned integer |
| portion_mip_blocks_in_intra_area[ t ] | 8 | unsigned integer |
| } | | |
| else { | | |
| portion_bi_and_gpm_predicted_blocks_area[ t ] | 8 | unsigned integer |
| } | | |
| portion_deblocking_instances[ t ] | 8 | unsigned integer |
| portion_sao_filtered_blocks[ t ] | 8 | unsigned integer |
| portion_alf_filtered_blocks[ t ] | 8 | unsigned integer |
| } | | |
| } | | |

The parameter TotalNum4BlocksInSegment[1] that defines the number of 4-samples blocks in the segment, the segment being a slice or tile when type_segments is equal to “0”, and a subpicture when type_segments is equal to “1”, is then defined as follows:
TotalNum4BlocksInSegment[t] is the total number of 4-samples blocks in the slice[t] or tile[t] or subpicture[t] and MaxNumDbfInstancesInSegment[t] is the maximum number of deblocking instances in the slice[t] or tile[t] or subpicture[t]. TotalNum4BlocksInSegment[t] and MaxNumDbfInstancesInSegment[t] are determined by the following computation.
   If type_segments is equal to 0, TotalNum4BlocksInSegment[t] is derived as follows from the syntax elements sps_subpic_ctu_top_left_x and sps_subpic_ctu_top_left_y specified in the clause “Sequence parameter set RBSP semantics” in ISO/IEC 23090-3:
      ctbAddrX is set equal to first_ctb_in_segment[t]
      tileColIdx is set equal to ctbToTileColIdx[ctbAddrX]
      tileRowIdx is set equal to ctbToTileRowIdx[ctbAddrX]
      tileWidth is set equal to ColWidthVal[tileColIdx]<<(CtbLog 2SizeY−1)
      tileHeight is set equal to RowHeightVal[tileRowIdx]<<(CtbLog 2SizeY−1)
      TotalNum4BlocksInSegment[t] is set equal to (tileWidth*tileHeight)
      MaxNumDblInstancesInSegment[t] is set equal to ChromaFormatMultiplier*(tileWidth*tileHeight−2*(tileWidth+tileHeight))
   Otherwise if type_segments is equal to 1, TotalNum4BlocksInSegment[t] is derived as follows from the parameters ctbToTileColIdx, ctbToTileRowIdx, ColWidthVal and RowHeightVal specified in the clause “CTB raster scanning, tile scanning, and subpicture scanning processes” in ISO/IEC 23090-3:
      subpicWidth is set equal to (1+sps_subpic_width_minus1[t])<<(CtbLog 2SizeY−1)
      subpicHeight is set equal to (1+sps_subpic_height_minus1[t])<<(CtbLog 2SizeY−1)
      TotalNum4BlocksInSegment[t] is set equal to (subpicWidth*subpicHeigh)
      MaxNumDblInstancesInSegment[t] is set equal to ChromaFormatMultiplier*(subpicWidth*subpicHeight−2*(subpicWidth+subpicHeight))

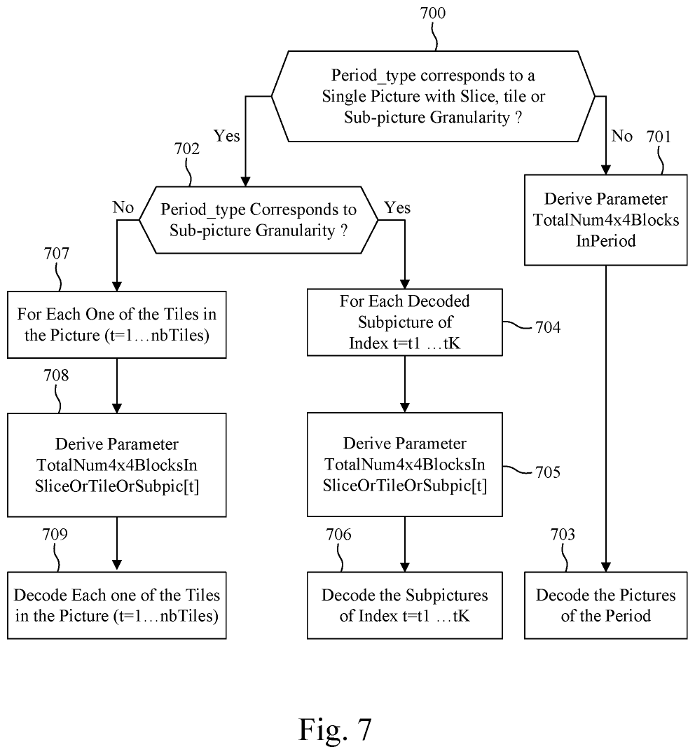

FIG. 7 illustrates a block diagram of a decoding process according to embodiments.

In a step 700, the processing module 500 checks the parameter period_type.

If period_type does not correspond to a single picture with slice, tile or subpicture granularity, the processing module 500 derive the parameter TotalNum4×4BlocksInPeriod in a step 701.

Then, in a step 703, the processing module 500 decodes the pictures of the period, by taking into account the value of TotalNum4×4BlocksInPeriod to derive the usage ratio of the coding modes during the period, and thus reduce decoder power consumption.

If, in step 700, period_type corresponds to a single picture with slice, tile or subpicture granularity, the processing module 500 checks the parameter period_type again in a step 702.

If, in step 702, period_type corresponds to a subpicture granularity, for K subpictures to be decoded, indexed by index t going from t1 to tK (step 704), the processing module 500 derive the parameter TotalNum4×4BlocksInSliceOrTileOrSubpic[t] according to the process described above for the value period_type=5 in step 705.

Then, the processing module 500 decodes the subpicture of index t in a step 706, by taking into account the value of TotalNum4×4BlocksInSliceOrTileOrSubpic[t] to derive the usage ratio of the coding modes in the subpicture, and thus reduce decoder power consumption.

If, in step 702, period_type does not correspond to a subpicture granularity, for each of the tiles to be decoded, indexed by index t going from t1 to nbTiles (step 707), the processing module 500 derives the parameter TotalNum4×4BlocksInSliceOrTileOrSubpic[t] according to the process described above for the value period_type=4 in a step 708.

Then, in a step 709, the processing module 500 decodes the tile of index t, by taking into account the value of TotalNum4×4BlocksInSliceOrTileOrSubpic[t] to derive the usage ratio of the coding modes in the tile, and thus reduce decoder power consumption.

In an embodiment, in case of period_type corresponding to subpicture granularity, the decoder can use a backward channel indicating to the encoder which subpictures are relevant, so that only the usage ratio values corresponding to those subpictures are computed and signaled in the SEI.

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described syntax elements, or variations thereof
Creating and/or transmitting and/or receiving and/or decoding a bitstream or signal that includes one or more of the described syntax elements, or variations thereof
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting image.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.

1. A method comprising:
signaling in a data structure metadata representative of an energy consumption induced by encoding tools and/or features implemented to obtain a video stream representative of a sequence of pictures; and,
associating the data structure to the video stream for at least one subset of pictures representative of a period of the video stream; wherein at least one encoding tool or feature is associated to an information representative of an energy consumption depending on:
a number of rectangular blocks comprising a number of samples equal to at least one value in a plurality of values.

2. The method of claim 1 wherein the data structure is a supplemental enhancement information (SEI) message.

3. (canceled)

4. The method of claim 1, wherein the at least one encoding tool or feature associated to an information representative of an energy consumption depending on the number of rectangular blocks comprising a number of samples equal to at least one value in a plurality of value signaled in the metadata is related to at least one of:
entropy decoding;
inverse transform;
intra prediction and intra blocks decoding;
inter prediction and inter blocks decoding;
interpolation for temporal prediction;
in-loop filtering;
a use of subpictures.

5. The method of claim 1 wherein the information representative of an energy consumption is applicable to a single picture or to all pictures in decoding order up to a next picture containing an intra slice, or over a specified time interval, or over a specified number of pictures counted in decoding order, or to a single picture with a slice, or tile granularity, or to a single picture with subpicture granularity.

6. The method according to claim 5, wherein:
a first method is applied to derive the total number of blocks of a given size in pictures responsive to the information representative of an energy consumption is applicable to a single picture with a slice or tile granularity; and
a second method is applied to derive the total number of blocks of a given size in pictures responsive to the information representative of an energy consumption is applicable to a single picture with subpicture granularity.

7. (canceled)

8. A method comprising:
obtaining a data structure associated to a video stream for at least one subset of pictures representative of a period of a sequence of pictures represented by the video stream and comprising metadata representative of an energy consumption induced by encoding tools and/or features implemented to obtain the video stream wherein at least one encoding tool or feature is associated to an information representative of an energy consumption depending on:
a number of samples per rectangular blocks comprising a number of samples equal to at least one value in a plurality of values.

9. The method of claim 8 wherein the data structure is a supplemental enhancement information (SEI) message.

10. (canceled)

11. The method of claim 8, wherein the at least one encoding tool or feature associated to an information representative of an energy consumption depending on the total number of blocks of the given size in pictures signaled in the metadata is related to at least one of:
entropy decoding;
inverse transform;
intra prediction and intra blocks decoding;
inter prediction and inter blocks decoding;
interpolation for temporal prediction;
in-loop filtering;
a use of subpictures.

12. The method of claim 8 wherein the information representative of an energy consumption is applicable to a single picture or to all pictures in decoding order up to a next picture containing an intra slice, or over a specified time interval, or over a specified number of pictures counted in decoding order, or to a single picture with a slice, or tile granularity, or to a single picture with subpicture granularity.

13. The method according to claim 12, wherein:
A first method is applied to derive the total number of blocks of a given size in pictures responsive to the information representative of an energy consumption is applicable to a single picture with a slice or tile granularity; and
a second method is applied to derive the total number of blocks of a given size in pictures responsive to the information representative of an energy consumption is applicable to a single picture with subpicture granularity.

14. (canceled)

15. A device comprising electronic circuitry configured for:
signaling in a data structure metadata representative of an energy consumption induced by encoding tools and/or features implemented to obtain a video stream representative of a sequence of pictures; and
associating the data structure to the video stream for at least one subset of pictures representative of a period of the video stream; wherein at least one encoding tool or feature is associated to an information representative of an energy consumption depending on:
a number of rectangular blocks comprising a number of samples equal to at least one value in a plurality of values.

16. The device of claim 15 wherein the data structure is a supplemental enhancement information (SEI) message.

17. (canceled)

18. The device of claim 15, wherein the at least one encoding tool or feature associated to an information representative of an energy consumption depending on the total number of blocks of the given size in pictures signaled in the metadata is related to at least one of:
entropy decoding;
inverse transform;
intra prediction and intra blocks decoding;
inter prediction and inter blocks decoding;
interpolation for temporal prediction;
in-loop filtering;
a use of subpictures.

19. The device of claim 15 wherein the information representative of an energy consumption is applicable to a single picture or to all pictures in decoding order up to a next picture containing an intra slice, or over a specified time interval, or over a specified number of pictures counted in decoding order, or to a single picture with a slice, or tile granularity, or to a single picture with subpicture granularity.

20. The device according to claim 19, wherein the electronic circuitry is configured for:
deriving the total number of blocks of a given size in pictures responsive to the information representative of an energy consumption is applicable to a single picture with a slice or tile granularity; and
deriving the total number of blocks of a given size in pictures responsive to the information representative of an energy consumption is applicable to a single picture with subpicture granularity.

21. (canceled)

22. A device comprising electronic circuitry configured for:
obtaining a data structure associated to a video stream for at least one subset of pictures representative of a period of a sequence of pictures represented by the video stream and comprising metadata representative of an energy consumption induced by encoding tools and/or features implemented to obtain the video stream wherein at least one encoding tool or feature is associated to an information representative of an energy consumption depending on:
a number of rectangular blocks comprising a number of samples equal to at least one value in a plurality of values.

23. The device of claim 22 wherein the data structure is a supplemental enhancement information (SEI) message.

24. (canceled)

25. The device of claim 21, wherein the at least one encoding tool or feature associated to an information representative of an energy consumption depending on the total number of blocks of the given size in pictures signaled in the metadata is related to at least one of:
entropy decoding;
inverse transform;
intra prediction and intra blocks decoding;
inter prediction and inter blocks decoding;
interpolation for temporal prediction;
in-loop filtering;
a use of subpictures.

26. The device of claim 22 wherein the information representative of an energy consumption is applicable to a single picture or to all pictures in decoding order up to a next picture containing an intra slice, or over a specified time interval, or over a specified number of pictures counted in decoding order, or to a single picture with a slice, or tile granularity, or to a single picture with subpicture granularity.

27. The device according to claim 26, wherein the electronic circuitry is configured for:
deriving the total number of blocks of a given size in pictures responsive to the information representative of an energy consumption is applicable to a single picture with a slice or tile granularity; and
deriving the total number of blocks of a given size in pictures responsive to the information representative of an energy consumption is applicable to a single picture with subpicture granularity.

28-32. (canceled)
